(19) United States
(12) Patent Application Publication
(10) Pub. No.: US 2021/0329650 A1
(43) Pub. Date: Oct. 21, 2021

(54) SIDELINK COMMUNICATIONS METHOD, NETWORK DEVICE, AND TERMINAL DEVICE

(71) Applicant: HUAWEI TECHNOLOGIES CO., LTD., Shenzhen (CN)

(72) Inventors: Lili ZHANG, Beijing (CN); Xingwei ZHANG, Lund (SE)

(21) Appl. No.: 17/360,182

(22) Filed: Jun. 28, 2021

Related U.S. Application Data
(63) Continuation of application No. PCT/CN2019/125954, filed on Dec. 17, 2019.

(30) Foreign Application Priority Data
Dec. 29, 2018 (CN) 201811641301.7

(51) Int. Cl. H04W 72/04

(52) U.S. Cl. CPC H04W 72/0493; H04W 92/18; H04W 72/042; H04W 72/0446

(57) ABSTRACT

This application provides a sidelink communications method, a terminal device, and a network device. The sidelink communications method includes: A network device determines downlink control information, and carries first indication information in the downlink control information, where the first indication information is used to indicate slot formats corresponding to N1 terminal device groups, and N1 is a positive integer. The network device sends the downlink control information to terminal devices in the N1 terminal device groups. According to the technical solution provided in this application, the network device may configure a slot format for a terminal device in a terminal device group.

### CROSS-REFERENCE TO RELATED APPLICATIONS

This application is a continuation of International Application No. PCT/CN2019/125954, filed on Dec. 17, 2019, which claims priority to Chinese Patent Application No. 201811641301.7, file on Dec. 29, 2018. The disclosures of the aforementioned applications are hereby incorporated by reference in their entireties.

### TECHNICAL FIELD

This application relates to the field of communications technologies, and more specifically, to a sidelink communications method, a network device, and a terminal device.

### BACKGROUND

Communications manners in a vehicle-to-everything (vehicle to everything, V2X) system are collectively referred to as V2X communication (X represents anything). For example, the V2X communication includes vehicle-to-vehicle (vehicle to vehicle, V2V) communication, vehicle-to-infrastructure (vehicle to infrastructure, V2I) communication, vehicle-to-pedestrian (vehicle to pedestrian, V2P) communication, or vehicle-to-network (vehicle to network, V2N) communication. Communication performed between terminal devices in the V2X system is widely referred to as sidelink (sidelink, SL) communication.

When a terminal device communicates with a network device or another terminal device, the network device configures a slot format for the terminal device in time domain, where the slot format can indicate different transmission statuses of the terminal device in a plurality of symbols in one slot. The transmission status may be an uplink transmission state, a downlink transmission state, or a flexible transmission state. Specifically, in a 5th generation new radio (5th generation new radio, 5G NR) system, the network device configures a slot format (slot format, SF) of the slot by using semi-static or dynamic signaling. Dynamic configuration means that the slot format is configured by using a slot format indicator (slot format indicator, SFI) in downlink control information (downlink control information, DCI) signaling. How a terminal device in a terminal device group determines a slot format to implement sidelink groupcast communication between terminal devices in the terminal device group becomes an urgent problem to be resolved.

### SUMMARY

This application provides a sidelink communications method, a network device, and a terminal device. The network device can configure a slot format for a terminal device in a terminal device group, to implement sidelink groupcast communication between terminal devices in the terminal device group.

According to a first aspect, a sidelink communications method is provided, and includes: A network device determines downlink control information, where the downlink control information carries first indication information, the first indication information is used to indicate slot formats corresponding to N1 terminal device groups, and one terminal device group includes a plurality of terminal devices that perform sidelink groupcast communication, where N1 is a positive integer. The network device sends the downlink control information.

According to the sidelink communications method in this embodiment of this application, the first indication information is carried in the downlink control information delivered by the network device, where the first indication information indicates a slot format corresponding to a terminal device group, so that a slot format can be configured for the terminal device group.

It should be understood that an information segment in this embodiment of this application refers to some information included in the first indication information carried in the downlink control information, and may also be referred to as an information segment, an information field, an information position, an information unit, a field, or the like.

With reference to the first aspect, in some implementations of the first aspect, N1 is equal to 1; and that the first indication information is used to indicate slot formats corresponding to N1 terminal device groups includes: the first indication information is used to indicate slot formats corresponding to N terminal devices in a first terminal device group, the first indication information includes N information segments, and one of the N information segments is used to indicate a slot format corresponding to one terminal device in the first terminal device group.

According to the sidelink communications method in this embodiment of this application, the first indication information carried in the downlink control information may be used to indicate slot formats corresponding to N terminal devices in one terminal device group, so as to configure slot formats for terminal devices in one terminal device group.

It should be understood that the N terminal devices in one terminal device group may be a part of terminal devices in the terminal device group, or may be all terminal devices in the terminal device group.

For example, the terminal device group includes N2 terminal devices that perform sidelink groupcast communication, where N2 is an integer greater than 2 and greater than or equal to N.

With reference to the first aspect, in some implementations of the first aspect, N1 is greater than 1; and the first indication information is used to indicate the slot formats corresponding to the N1 terminal device groups, the first indication information includes N1 information segments, and one of the N1 information segments is used to indicate a slot format corresponding to one of the N1 terminal device groups.

According to the sidelink communications method in this embodiment of this application, the first indication information carried in the downlink control information may be used to indicate slot formats corresponding to a plurality of terminal device groups, so as to configure slot formats for a plurality of terminal device groups.

With reference to the first aspect, in some implementations of the first aspect, a correspondence between the N information segments and the N terminal devices is preconfigured, or the method further includes: The network device sends a second message to the N terminal devices, where the second message includes a correspondence between the N information segments and the N terminal devices.

According to the sidelink communications method in this embodiment of this application, the network device may establish the correspondence between the N information segments and the N terminal devices, and notify the N terminal devices of the correspondence between the N information segments and the N terminal devices by using the second message. Alternatively, the correspondence between the N information segments and the N terminal devices is preconfigured in the network device and/or the N terminal devices, so that the N terminal devices can learn of the correspondence between the N information segments and the N terminal devices, and obtain corresponding information segments based on the correspondence.

It should be understood that the correspondence between the N information segments and the N terminal devices is a one-to-one correspondence between the N information segments and the N terminal devices, and one information segment is used to indicate a slot format of a terminal device that is in the one-to-one correspondence with the information segment.

It should be further understood that the one-to-one correspondence between the N information segments and the N terminal devices in this embodiment of this application may be a one-to-one correspondence between the N information segments and identifiers of the N terminal devices. The identifier of the terminal device is a relative identifier or an absolute identifier of the terminal device in a terminal device group to which the terminal device belongs. The absolute identifier may be a radio network temporary identifier (radio network temporary identity, RNTI).

With reference to the first aspect, in some implementations of the first aspect, the downlink control information further includes second indication information, and the second indication information is used to identify the N terminal devices.

According to the sidelink communications method in this embodiment of this application, the second indication information may be carried in the downlink control information, to notify a terminal device that receives the downlink control information that an information segment in the first indication information can determine slot formats of which terminal devices.

With reference to the first aspect, in some implementations of the first aspect, the second indication information includes an identifier of a start terminal device in the N terminal devices; or the second indication information includes an identifier of each of the N terminal devices.

According to the sidelink communications method in this embodiment of this application, the second indication information may indicate only the identifier of the start terminal device in the N terminal devices, and the N terminal devices can be determined based on the identifier of the start terminal device. Alternatively, the second indication information may include the identifier of each of the N terminal devices.

With reference to the first aspect, in some implementations of the first aspect, a correspondence between the N1 information segments and the N1 terminal device groups is preconfigured, or the method further includes: The network device sends a third message to terminal devices in the N1 terminal device groups, where the third message includes a correspondence between the N1 information segments and the N1 terminal device groups.

According to the sidelink communications method in this embodiment of this application, the network device may establish the correspondence between the N1 information segments and the N1 terminal device groups, and notify terminal devices in the N1 terminal device groups of the correspondence between the N1 information segments and the N1 terminal device groups by using the second message. Alternatively, the correspondence between the N1 information segments and the N1 terminal device groups is preconfigured in the network device and/or terminal devices in the N1 terminal device groups, so that the terminal devices in the N1 terminal device groups can learn of the correspondence between the N1 information segments and the N1 terminal device groups, and obtain, based on the correspondence, information segments corresponding to terminal device groups to which the terminal devices belong.

It should be understood that the correspondence between the N1 information segments and the N1 terminal device groups is a one-to-one correspondence between the N1 information segments and the N1 terminal device groups, and one information segment is used to indicate a slot format of a terminal device group that is in the one-to-one correspondence with the information segment.

It should be further understood that the one-to-one correspondence between the N1 information segments and the N1 terminal device groups in this embodiment of this application may be a one-to-one correspondence between the N1 information segments and identifiers of the N1 terminal device groups. The identifier of the terminal device group is information that can uniquely determine the terminal device group in a sidelink communications system within coverage of the network device.

With reference to the first aspect, in some implementations of the first aspect, the downlink control information further includes fourth indication information, and the fourth indication information is used to identify the N1 terminal device groups.

According to the sidelink communications method in this embodiment of this application, the fourth indication information may be carried in the downlink control information, to notify a terminal device that receives the downlink control information that an information segment in the first indication information can determine slot formats of which terminal device groups.

With reference to the first aspect, in some implementations of the first aspect, the fourth indication information includes an identifier of a start terminal device group in the N1 terminal device groups; or the fourth indication information includes an identifier of each of the N1 terminal device groups.

With reference to the first aspect, in some implementations of the first aspect, the slot format corresponding to the terminal device group is a slot format corresponding to a terminal device that is in a terminal device group and that is used as a sender.

According to the sidelink communications method in this embodiment of this application, when the network device indicates, by using an information segment in one piece of first indication information, a slot format corresponding to a terminal device group, the information segment indicates a slot format corresponding to a terminal device that performs information sending and that is in the terminal device group. Because communication between terminal devices in the terminal device group is groupcast communication, one terminal device performs sending, and another terminal device in the terminal device group performs receiving.

With reference to the first aspect, in some implementations of the first aspect, before the network device sends the downlink control information, the method further includes: The network device scrambles the downlink control information by using a first identifier, where the first identifier is preconfigured or notified by using semi-static signaling.

According to the sidelink communications method in this embodiment of this application, the network device scrambles the sent downlink control information based on the first identifier. To enable a terminal device that receives the downlink control information to parse the downlink control information, in this application, the first identifier may be notified to terminal devices in the N1 terminal device groups by using the semi-static signaling, or the first identifier is preconfigured.

With reference to the first aspect, in some implementations of the first aspect, the method further includes: The network device sends third indication information to terminal devices in the N1 terminal device groups, where the third indication information is used to indicate a first search space, and the first search space is a search space for detecting the downlink control information.

According to the sidelink communications method in this embodiment of this application, to simplify detection of the downlink control information by the terminal device, the network device determines the first search space, and notifies the terminal device of the first search space by using the third indication information.

According to a second aspect, a sidelink communications method is provided, and includes: A terminal device receives downlink control information sent by a network device, where the downlink control information carries first indication information, the first indication information is used to indicate slot formats corresponding to N1 terminal device groups, and one terminal device group includes a plurality of terminal devices that perform sidelink groupcast communication, where N1 is a positive integer. The terminal device parses the downlink control information.

According to the sidelink communications method in this embodiment of this application, the first indication information is carried in the downlink control information received by the terminal device, where the first indication information indicates a slot format corresponding to a terminal device group, so that a slot format can be configured for the terminal device group.

With reference to the second aspect, in some implementations of the second aspect, N1 is equal to 1; and that the first indication information is used to indicate slot formats corresponding to N1 terminal device groups includes: the first indication information is used to indicate slot formats corresponding to N terminal devices in a first terminal device group, the first indication information includes N information segments, and one of the N information segments is used to indicate a slot format corresponding to one terminal device in the first terminal device group.

According to the sidelink communications method in this embodiment of this application, the first indication information carried in the downlink control information may be used to indicate slot formats corresponding to N terminal devices in one terminal device group, so as to configure slot formats for terminal devices in one terminal device group.

With reference to the second aspect, in some implementations of the second aspect, N1 is greater than 1; and the first indication information is used to indicate the slot formats corresponding to the N1 terminal device groups, the first indication information includes N1 information segments, and one of the N1 information segments is used to indicate a slot format corresponding to one of the N1 terminal device groups.

According to the sidelink communications method in this embodiment of this application, the first indication information carried in the downlink control information may be used to indicate slot formats corresponding to a plurality of terminal device groups, so as to configure slot formats for a plurality of terminal device groups.

With reference to the second aspect, in some implementations of the second aspect, a correspondence between the N information segments and the N terminal devices is preconfigured, or the method further includes: The terminal device receives a second message sent by the network device, where the second message includes a correspondence between the N information segments and the N terminal devices.

According to the sidelink communications method in this embodiment of this application, the terminal device receives the second message that is sent by the network device and that carries the correspondence between the N information segments and the N terminal devices. Alternatively, the correspondence between the N information segments and the N terminal devices is preconfigured in the network device and/or the N terminal devices, so that the N terminal devices can learn of the correspondence between the N information segments and the N terminal devices, and obtain corresponding information segments based on the correspondence.

With reference to the second aspect, in some implementations of the second aspect, the downlink control information further includes second indication information, and the second indication information is used to identify the N terminal devices.

According to the sidelink communications method in this embodiment of this application, the second indication information may be carried in the downlink control information, to notify a terminal device that receives the downlink control information that an information segment in the first indication information can determine slot formats of which terminal devices.

With reference to the second aspect, in some implementations of the second aspect, the second indication information includes an identifier of a start terminal device in the N terminal devices; or the second indication information includes an identifier of each of the N terminal devices.

According to the sidelink communications method in this embodiment of this application, the second indication information may indicate only the identifier of the start terminal device in the N terminal devices, and the N terminal devices can be determined based on the identifier of the start terminal device. Alternatively, the second indication information may include the identifier of each of the N terminal devices.

With reference to the second aspect, in some implementations of the second aspect, a correspondence between the N1 information segments and the N1 terminal device groups is preconfigured, or the method further includes: The terminal device receives a third message sent by the network device, where the third message includes a correspondence between the N1 information segments and the N1 terminal device groups.

According to the sidelink communications method in this embodiment of this application, the terminal device receives the third message that is sent by the network device and that carries the correspondence between the N1 information segments and the N1 terminal device groups. Alternatively, the correspondence between the N1 information segments and the N1 terminal device groups is preconfigured in the network device and/or terminal devices in the N1 terminal device groups, so that the terminal devices in the N1 terminal device groups can learn of the correspondence between the N1 information segments and the N1 terminal device groups, and obtain, based on the correspondence, information segments corresponding to terminal device groups to which the terminal devices belong.

With reference to the second aspect, in some implementations of the second aspect, the slot format corresponding to the terminal device group is a slot format corresponding to a terminal device that is in a terminal device group and that is used as a sender. The terminal device starts a transmission manner of automatic detection to detect, in the slot format corresponding to the terminal device group, a resource that can be transmitted, and determines a slot format of the terminal device based on a detection result. Alternatively, the terminal device allocates a resource to a terminal device in the terminal device group based on the slot format corresponding to the terminal device group, and determines a slot format of the terminal device.

According to the sidelink communications method in this embodiment of this application, when the network device indicates, by using an information segment in one piece of first indication information, a slot format corresponding to a terminal device group, the information segment indicates a slot format corresponding to a terminal device that performs information sending and that is in the terminal device group. Because communication between terminal devices in the terminal device group is groupcast communication, one terminal device performs sending, and another terminal device in the terminal device group performs receiving. The terminal device in the terminal device group starts the transmission manner of automatic detection to detect, in the slot format corresponding to the terminal device group, the resource that can be transmitted, and determines the slot format of the terminal device based on the detection result. Alternatively, the terminal device group includes a master terminal device, and the master terminal device allocates a resource to a terminal device in the terminal device group based on the slot format corresponding to the terminal device group, to determine a slot format of the terminal device in the terminal device group.

With reference to the second aspect, in some implementations of the second aspect, before the terminal device receives the downlink control information sent by the network device, the method further includes: The terminal device obtains a first identifier, where the first identifier is used to scramble the downlink control information. That the terminal device obtains the first identifier includes: the first identifier is preconfigured, or the terminal device receives semi-static signaling sent by the network device, where the semi-static signaling carries the first identifier.

According to the sidelink communications method in this embodiment of this application, the terminal device obtains, by receiving semi-static signaling delivered by the network device, the first identifier for scrambling the downlink control information, or the first identifier for scrambling the downlink control information is preconfigured.

With reference to the second aspect, in some implementations of the second aspect, the method further includes: The terminal device receives third indication information sent by the network device, where the third indication information is used to indicate a first search space, and the first search space is a search space for detecting the downlink control information.

According to the sidelink communications method in this embodiment of this application, to simplify detection of the downlink control information by the terminal device, the terminal device determines, by receiving the third indication information, the first search space for detecting the downlink control information.

According to a third aspect, a network device is provided. The network device may be configured to perform operations of the network device in any one of the first aspect or possible implementations of the first aspect. Specifically, the network device includes a corresponding component (means) configured to perform the steps or functions described in the first aspect, and the component may be the network device in the first aspect. The steps or functions may be implemented by using software, hardware, or a combination of hardware and software.

According to a fourth aspect, a terminal device is provided. The terminal device may be configured to perform operations of the terminal device in any one of the second aspect or possible implementations of the second aspect. Specifically, the terminal device may include a corresponding component (means) configured to perform the steps or functions described in the second aspect. The steps or functions may be implemented by using software, hardware, or a combination of hardware and software.

According to a fifth aspect, a sidelink communications apparatus is provided, and includes a processor and a memory. The memory is configured to store a computer program, and the processor is configured to invoke the computer program from the memory and run the computer program, so that the sidelink communications apparatus performs the sidelink communications method in any possible implementation of the first aspect or the second aspect.

In a possible implementation, there are one or more processors and one or more memories.

In a possible implementation, the memory may be integrated into the processor, or the memory and the processor are separately disposed.

Optionally, the sidelink communications apparatus further includes a transmitter (transmitter machine) and a receiver (receiver machine).

According to a sixth aspect, a system is provided. The system includes the foregoing network device and terminal device.

According to a seventh aspect, a computer program product is provided. The computer program product includes a computer program (which may also be referred to as code or an instruction). When the computer program is run, a computer is enabled to perform the method in any possible implementation of the first aspect or the second aspect.

According to an eighth aspect, a chip system is provided, and includes a memory and a processor, where the memory is configured to store a computer program, and the processor is configured to: invoke the computer program from the memory and run the computer program, so that a sidelink communications apparatus installed with the chip system performs the method in any possible implementation of the first aspect and the second aspect.

According to the sidelink communications method, the network device, and the terminal device in the embodiments of this application, the first indication information carried in the downlink control information delivered by the network device indicates a slot format corresponding to at least one terminal device group, so that a slot format can be configured for a terminal device in the terminal device group, thereby implementing sidelink groupcast communication between terminal devices in the terminal device group.

### BRIEF DESCRIPTION OF DRAWINGS

FIG. 1 is a schematic diagram of a V2X system in a conventional technology;

FIG. 2 is a schematic block diagram of a communications system to which an embodiment of this application is applicable;

FIG. 3(a) to FIG. 3(c) each are a schematic diagram of a terminal device group according to an embodiment of this application;

FIG. 4 is a schematic diagram of slot formats for sidelink communication;

FIG. 5 is another schematic diagram of slot formats for sidelink communication;

FIG. 6 is a schematic diagram of a sidelink communications method according to an embodiment of this application;

FIG. 7(a) to FIG. 7(e) each are a schematic diagram indicating a correspondence between information segments and terminal device groups according to an embodiment of this application;

FIG. 8 is a schematic diagram implementing a one-to-one correspondence between information segments and terminal devices according to an embodiment of this application;

FIG. 9 is another schematic diagram implementing a one-to-one correspondence between information segments and terminal devices according to an embodiment of this application;

FIG. 10 is a schematic diagram implementing a one-to-one correspondence between information segments and terminal device groups according to an embodiment of this application;

FIG. 11 is another schematic diagram implementing a one-to-one correspondence between information segments and terminal device groups according to an embodiment of this application;

FIG. 12 is a schematic diagram of a format of second indication information according to this application;

FIG. 13 is a schematic diagram indicating a slot format according to this application;

FIG. 14 is another schematic diagram indicating a slot format according to this application;

FIG. 15 is a schematic diagram of a sidelink communications apparatus 10 according to this application;

FIG. 16 is a schematic structural diagram of a terminal device 20 to which an embodiment of this application is applicable;

FIG. 17 is a schematic diagram of a sidelink communications apparatus 30 according to this application; and

FIG. 18 is a schematic structural diagram of a network device 40 to which an embodiment of this application is applicable.

### DESCRIPTION OF EMBODIMENTS

The following describes technical solutions in this application with reference to the accompanying drawings.

The technical solutions of embodiments of this application may be applied to various communications systems, for example, a global system for mobile communications (global system for mobile communications, GSM), a code division multiple access (code division multiple access, CDMA) system, a wideband code division multiple access (wideband code division multiple access, WCDMA) system, a general packet radio service (general packet radio service, GPRS), a long term evolution (long term evolution, LTE) system, an LTE frequency division duplex (frequency division duplex, FDD) system, an LTE time division duplex (time division duplex, TDD) system, a universal mobile telecommunications system (universal mobile telecommunication system, UMTS), a worldwide interoperability for microwave access (worldwide interoperability for microwave access, WiMAX) communications system, a future 5th generation (5th generation, 5G) system, or a new radio (new radio, NR) system.

A terminal device in the embodiments of this application may be user equipment, an access terminal, a subscriber unit, a subscriber station, a mobile station, a mobile console, a remote station, a remote terminal, a mobile device, a user terminal, a terminal, a wireless communications device, a user agent, or a user apparatus. The terminal device may alternatively be a cellular phone, a cordless phone, a session initiation protocol (session initiation protocol, SIP) phone, a wireless local loop (wireless local loop, WLL) station, a personal digital assistant (personal digital assistant, PDA), a handheld device having a wireless communications function, a computing device, another processing device connected to a wireless modem, a vehicle-mounted device, a wearable device, a terminal device in a future 5G network, a terminal device in a future evolved public land mobile communications network (public land mobile network, PLMN), or the like. This is not limited in the embodiments of this application.

A network device in the embodiments of this application may be a device configured to communicate with the terminal device. The network device may be a base transceiver station (base transceiver station, BTS) in the global system for mobile communications (global system for mobile communications, GSM) system or the code division multiple access (code division multiple access, CDMA) system, a NodeB (NodeB, NB) in the wideband code division multiple access (wideband code division multiple access, WCDMA) system, an evolved NodeB (evolved NodeB, eNB or eNodeB) in the LTE system, or a radio controller in a cloud radio access network (cloud radio access network, CRAN) scenario. Alternatively, the network device may be a relay node, an access point, a vehicle-mounted device, a wearable device, a network device in the future 5G network, a network device in the future evolved PLMN network, or the like. This is not limited in the embodiments of this application.

In the embodiments of this application, the terminal device or the network device includes a hardware layer, an operating system layer running above the hardware layer, and an application layer running above the operating system layer. The hardware layer includes hardware such as a central processing unit (central processing unit, CPU), a memory management unit (memory management unit, MMU), and a memory (also referred to as a main memory). The operating system may be any one or more computer operating systems, for example, a Linux operating system, a Unix operating system, an Android operating system, an iOS operating system, or a Windows operating system, that implement service processing by using a process (process). The application layer includes applications such as a browser, an address book, word processing software, and instant messaging software. In addition, a specific structure of an execution body of a method provided in the embodiments of this application is not specifically limited in the embodiments of this application, provided that a program that records code of the method provided in the embodiments of this application can be run to perform communication according to the method provided in the embodiments of this application. For example, the method provided in the embodiments of this application may be performed by the terminal device or the network device, or a function module that can invoke and execute the program in the terminal device or the network device.

In addition, aspects or features of this application may be implemented as a method, an apparatus, or a product that uses standard programming and/or engineering technologies. The term “product” used in this application covers a computer program that can be accessed from any computer-readable component, carrier or medium. For example, the computer-readable medium may include but is not limited to: a magnetic storage component (for example, a hard disk, a floppy disk, or a magnetic tape), an optical disc (for example, a compact disc (compact disc, CD) or a digital versatile disc (digital versatile disc, DVD)), a smart card and a flash memory component (for example, an erasable programmable read-only memory (erasable programmable read-only memory, EPROM), a card, a stick, or a key drive). In addition, various storage media described in this specification may indicate one or more devices and/or other machine-readable media that are configured to store information. The term “machine-readable media” may include but is not limited to a wireless channel, and various other media that can store, include, and/or carry an instruction and/or data.

With continuous development of the society, popularity of vehicles has soared. The vehicle brings convenience to people in traveling, and has some negative impact on human society. A rapid increase in a quantity of vehicles causes a series of problems such as urban traffic congestion, frequent traffic accidents, and worse environment quality. In consideration of personal safety, traffic efficiency, environmental protection, economic effects, and the like, a comprehensive intelligent transportation system (intelligent transportation system, ITS) is required. Currently, the ITS has naturally become a worldwide focus.

Currently, a vehicle may obtain road condition information or receive service information in time in V2V, V2I, V2P, or V2N communications manner. The communications manners may be collectively referred to as V2X communication.

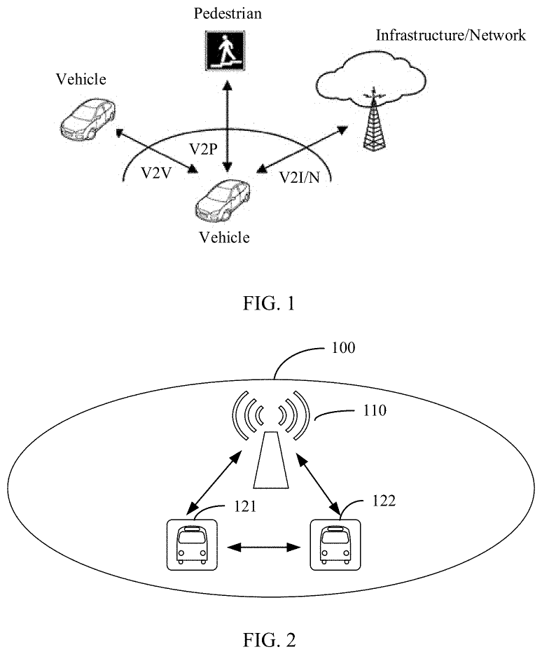

FIG. 1 is a schematic diagram of a V2X system in a conventional technology. The schematic diagram includes V2V communication, V2P communication, and V2I/N communication.

As shown in FIG. 1, vehicles communicate with each other through the V2V communication. A vehicle may broadcast, to a surrounding vehicle, information such as a vehicle speed, a driving direction, a specific position, and whether an emergency brake is pressed. A driver of the surrounding vehicle can better learn of a traffic status outside a line of sight by obtaining the information, and therefore, can predict and avoid a risk status in advance. V2I communication is performed between the vehicle and a road side infrastructure, and the road side infrastructure can provide various service information and data network access for the vehicle. Functions such as electronic toll collection and intra-vehicle entertainment can greatly improve traffic intelligence. The road side infrastructure, for example, a road side unit (road side unit, RSU) includes two types: One type is an RSU of a terminal device type. Because the RSU is distributed on a road side, the RSU of the terminal device type is in a non-moving state, and mobility does not need to be considered. The other type is an RSU of a network device type. The RSU of the network device type may provide timing synchronization and resource scheduling for a vehicle communicating with a network device. V2P communication is performed between a vehicle and a person (for example, a vehicle and a pedestrian, a vehicle and a cyclist, a vehicle and a driver, or a vehicle and a passenger). V2N communication is performed between a vehicle and a network, and V2N and the foregoing V2I may be collectively referred to as V2I/N.

It should be understood that FIG. 1 is merely a schematic diagram of an example shown for describing the V2X system, and constitutes no limitation on this application. For example, there may be a plurality of vehicles, pedestrians, and infrastructures, and a quantity of the vehicles, pedestrians, and infrastructures is not a quantity shown in FIG. 1.

FIG. 1 briefly describes the V2X system in a conventional technology. With reference to FIG. 2, the following briefly describes a scenario to which implementations provided in this application are applicable.

FIG. 2 is a schematic block diagram of a communications system to which an embodiment of this application is applicable. As shown in FIG. 2, in the communications system 100, before data transmission, a terminal device 121 and a network device 110 may determine, through signaling interaction, a resource used for data transmission with a terminal device 122, and then the terminal device 121 communicates with the terminal device 122 by using the determined resource. Alternatively, before data transmission, a terminal device 122 and a network device 110 may determine, through signaling interaction, a resource used for data transmission with a terminal device 121, and then the terminal device 122 communicates with the terminal device 121 by using the determined resource. That is, this embodiment of this application is applied to an application scenario of sidelink data transmission.

It should be understood that FIG. 2 is merely a schematic diagram and does not constitute any limitation on the protection scope of this application. For example, a quantity of terminal devices shown in FIG. 2 is merely an example.

It should be further understood that communication between terminal devices in the foregoing V2X system is referred to as sidelink communication in this application, and this does not constitute any limitation on this application. For example, the sidelink communication may alternatively be referred to as sidelink communication, direct connection link communication, secondary link communication, or the like. In addition, the communication is not necessarily limited to the V2X system. In another scenario, communication between terminal devices may also be referred to as sidelink communication.

FIG. 2 describes a scenario to which this embodiment of this application can be applied. For ease of understanding of the technical solutions of this application, the following briefly describes several basic concepts in the technical solutions of this application.

1. Slot.

First, it should be understood that 5G NR mobile communication needs to have higher performance than 4th generation (4th generation, 4G) mobile communication.

The Release 15 protocol in a 5G new radio access technology (5th generation new radio access technology, 5G NR RAT) defines a new air-interface access technology. The air-interface access technology supports a user experience rate of 0.1 to 1 gigabit per second (gigabit per second, Gbps), a connection density of one million connections per square kilometer, an end-to-end millisecond-level latency, a traffic density of dozens of terabits per second (terabit per second, Tbps) per square kilometer, mobility of over 500 Km per hour, and a peak rate of dozens of Gbps. The user experience rate, the connection density, and the latency are three most basic performance indicators for 5G. In addition, efficiency of network device deployment and operation needs to be greatly improved in 5G. Compared with 4G, in 5G, spectrum efficiency is to be increased by 5 to 15 times, and energy efficiency and cost efficiency are to be increased by more than 100 times.

Three application scenarios of 5G NR include enhanced mobile broadband (enhanced mobile broadband, eMBB), massive machine-type communications (massive machine-type-communications, mMTC), and ultra-reliable low-latency communication (ultra reliable and low latency communications, URLLC).

The URLLC application scenario includes unmanned driving, industrial control, and the like. The URLLC application scenario requires a low latency and high reliability. Specific requirements for the low latency are an end-to-end 0.5 ms latency and a 1 ms round-trip latency of air-interface information exchange, and a specific requirement for the high reliability is that a block error rate (block error rate, BLER) reaches 10\hat{ }(−5), that is, a proportion of correctly received data packets reaches 99.999%.

In 5G NR, a plurality of subcarrier spacings are introduced, and different carriers may have different subcarrier spacings. A baseline is 15 kHz. The subcarrier spacing may be 15 kHz*2\hat{ }ⁿ, where n is an integer, and the subcarrier spacing ranges from 3.75 kHz, 7.5 kHz, to 480 kHz. There are a maximum of eight subcarrier spacings. Corresponding to different subcarrier spacings, there are a plurality of symbol lengths and slot lengths, as shown in the following table 1.

TABLE 1

| Subcarrier spacing | f0 | f1 | f2 |
|---|---|---|---|
| Symbol length | S0 | S0 | S0 |
| | | | S1 |
| | | S1 | S2 |
| | | | S3 |
| | S1 | S2 | S4 |
| | | | S5 |
| | | S3 | S6 |
| | | | S7 |
| | S2 | S4 | S8 |
| | | | S9 |
| | | S5 | S10 |
| | | | S11 |
| | S3 | S6 | S12 |
| | | | S13 |
| | | S7 | S14 |
| | | | S15 |
| | S4 | S8 | S16 |
| | | | S17 |
| | | S9 | S18 |
| | | | S19 |

In the table 1, S refers to a symbol (symbol). It can be learned from the table that, when the subcarrier spacing is f0, a corresponding symbol length is twice a corresponding symbol length that exists when the subcarrier spacing is f1, and is four times a corresponding symbol length that exists when the subcarrier spacing is f2.

It should be understood that the table 1 is merely an example table, and is used to describe a case in which there are a plurality of different symbol lengths corresponding to different subcarrier spacings. This does not constitute any limitation on this application.

The slot may also have different slot types, and different slot types include different quantities of symbols. For example, a quantity of symbols included in a mini slot (Mini slot) is less than 7. For example, a quantity of symbols included in the mini slot is 1, 2, 4, or the like. A quantity of symbols included in a common slot (Slot) is 7 or 14.

The following describes a sidelink communications method provided in this application by using an example in which a common slot includes 14 symbols. However, a specific form of the slot is not limited in this embodiment of this application.

2. Slot Format.

In time domain, in 5G NR, one slot may include at least one of a downlink transmission symbol, a flexible symbol, an uplink transmission symbol, and the like, and compositions of different slots implement different functions. Compositions of different slots are referred to as different slot formats (slot format, SF). The downlink transmission symbol is used for downlink transmission, the uplink transmission symbol is used for uplink transmission, and the flexible symbol is used for configurable directions (a transmission direction may be changed by a terminal device-specific radio resource control (radio resource control, RRC) configuration, or a transmission direction may be changed by downlink control information (downlink control information, DCI)), a gap (gap), or a guard period (guard period, GP).

Specifically, a transmission status of each symbol included in the slot is any one of the following:

an uplink (uplink, UL) transmission state, a downlink (downlink, DL) transmission state, and an unknown (unknown) state. The three states may be denoted as UL/DL/X (or U/D/X for short). X is referred to as an unknown state or a flexible (flexible) state, and the terminal device neither receives nor sends information on a symbol corresponding to the X state. X may also be referred to as F or U.

For example, a slot format_0 indicates that transmission statuses of 14 symbols included in one slot are all downlink transmission states; a slot format_1 indicates that transmission statuses of 14 symbols included in one slot are all uplink transmission states; a slot format_2 indicates that transmission statuses of 14 symbols included in one slot are all non-uplink and non-downlink transmission states; and the like. In 5G NR, there may be a maximum of 256 slot formats, which are not enumerated herein.

Further, different slot formats include different quantities of uplink transmission symbols, different quantities of downlink transmission symbols, or different quantities of flexible symbols.

3. Configure the Slot Format.

5G NR supports semi-statically or dynamically configuring the slot format.

1. Semi-Statically Configure the Slot Format.

Specifically, the network device sends semi-static signaling to the terminal device, and the semi-static signaling is used to configure the slot format. For example, a transmission status, of a symbol included in each slot of a terminal device, in a period of time or in a periodicity of time period is notified by using RRC signaling. The semi-static signaling may be cell-specific (cell-specific), to be specific, all terminal devices in a cell receive the semi-static signaling to configure the slot format. Alternatively, the semi-static signaling may be dedicated signaling (dedicated signaling) of a terminal device (or some terminal devices), to be specific, the terminal device (or some terminal devices) receives (or receive) the semi-static signaling to configure the slot format.

2. Dynamically Configure the Slot Format.

In 5G NR, a slot format, in one or more slots of the terminal device, in a period of time or in a periodicity of time period is notified by using DCI signaling. The DCI signaling includes slot format indicator (slot format indicator, SFI) information, and therefore is referred to as dynamic SFI signaling.

Specifically, the SFI information is delivered by using DCI2_0 information. The DCI2_0 information may cover a state in which a transmission status of a symbol is unknown during semi-statically configuring the slot format. The DCI2_0 is a downlink control information format that is specified in a protocol and that is used to carry the SFI information.

In addition, a plurality of symbol status combinations of a plurality of slots are further predefined in 5G NR, and a table in which the combination is located is referred to as a terminal device-specific table (specific table). Specifically, the network device configures a slot format combination (slot format combination) in one or more slots by using the RRC signaling, where a combined sequence number identifier (entry identify, entry ID) may be used to indicate a specific slot format. In addition, the DCI signaling may dynamically indicate the slot format combination in the one or more slots. A maximum quantity of entries (max Nrof Slot format Combinations Per Set) in the specific table specific table is 512, and a maximum quantity of slots of each entry (max Nrof Slot formats Per Combination) is 256.

The following briefly describes the specific table specific table with reference to a table 2. The table 2 is a terminal device-specific table specific table.

TABLE 2

| Entry ID | Slot 1 | Slot 2 | Slot 3 | . . . | Slot m | . . . | Slot n | . . . | Slot 256 |
|---|---|---|---|---|---|---|---|---|---|
| 1 | s1 | s2 | s3 | . . . | sm | | | | |
| 2 | s1 | s2 | s3 | . . . | sm | . . . | sn | | |
| . . . | | | | | | | | | |
| 122 | s1 | s2 | s3 | . . . | sm | . . . | sn | . . . | s256 |
| . . . | | | | | | | | | |
| 512 | s1 | s2 | s3 | . . . | sm | | | | |

In the table 2, s refers to a symbol (symbol), and n and m are identifiers of different symbols.

First, the network device delivers, by using the RRC signaling, configuration information of an entry ID and a specific slot format table corresponding to the entry ID, where a horizontal axis indicates different slots in the combination, and a vertical axis indicates an entry ID. The table 2 includes a possible slot format combination of each entry.

Then, different DCI signaling is used to indicate that a corresponding configuration of a corresponding carrier is an entry ID in the table, and the DCI signaling is carried on a group common-physical downlink control channel (group common-physical downlink control channel, GC-PDCCH) channel. Each piece of SFI information carried in the DCI signaling is an entry ID corresponding to one slot format combination, and the DCI signaling may carry a total of 16 pieces of SFI information. The SFI information may be understood as an index (index) of an SFI. The network device configures the terminal device to periodically detect the GC-PDCCH and receive the DCI signaling that carries the SFI. The periodicity is referred to as a monitoring periodicity (monitor period).

4. Terminal Device Group.

In the V2X system, a plurality of terminal devices that perform sidelink communication may perform groupcast (groupcast) communication in a form of one group, and a group including the plurality of terminal devices may be referred to as a terminal device group. Usually, in groupcast communication, a terminal device in the terminal device group performs an action of sending information, and another terminal device in the terminal device group receives information sent by the terminal device. It should be understood that during groupcast communication, there are usually a plurality of terminal devices in the terminal device group. For example, each terminal device group has more than two terminal devices.

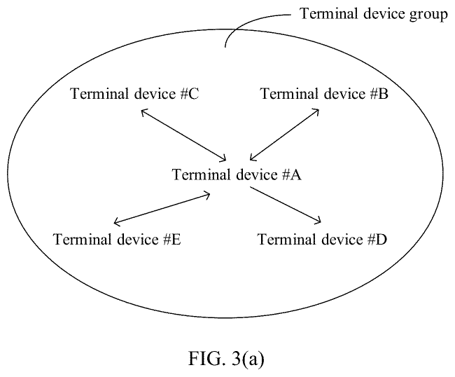

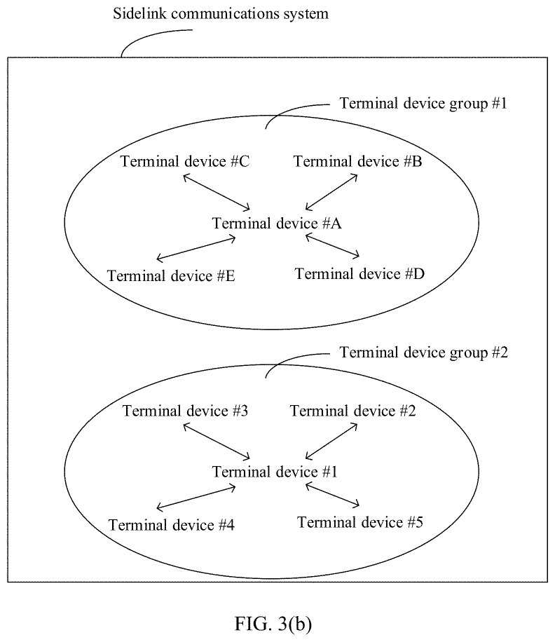

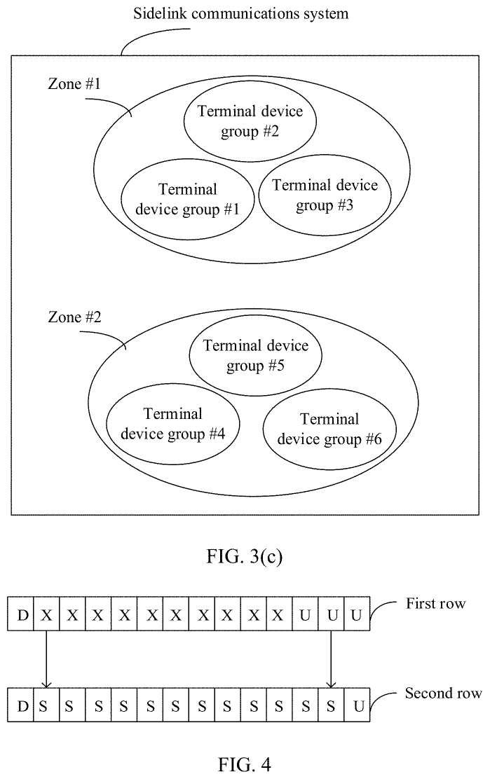

FIG. 3 is a schematic diagram of a terminal device group according to an embodiment of this application. The schematic diagram includes a plurality of terminal devices.

For example, as shown in FIG. 3(a), a terminal device #A is a terminal device that performs information sending and that is in the terminal device group, and a terminal device #B to a terminal device #E are terminal devices that perform information receiving and that are in the terminal device group.

For example, a sidelink communications system within coverage of a network device may include a plurality of terminal device groups that are related to each other. As shown in FIG. 3(b), a terminal device group #1 and a terminal device group #2 are two related terminal device groups. The terminal device group #1 includes the terminal device #A to the terminal device #E, the terminal device #A is a terminal device that performs information sending and that is in the terminal device group #1, and the terminal device #B to the terminal device #E are terminal devices that perform information receiving and that are in the terminal device group #1. The terminal device group #2 includes a terminal device #1 to a terminal device #5, the terminal device #1 is a terminal device that performs information sending and that is in the terminal device group #2, and the terminal device #2 to the terminal device #5 are terminal devices that perform information receiving and that are in the terminal device group #2.

Specifically, that the plurality of terminal device groups are related to each other means that resource coordination needs to be performed among the plurality of terminal device groups.

For example, the network device needs to coordinate time domain resources and/or frequency domain resources and/or code domain resources for a plurality of related terminal device groups.

It should be understood that FIG. 3(b) is merely an example, and does not constitute any limitation on this application. For example, a quantity of related terminal device groups included in the sidelink communications system within the coverage of the network device may be greater than a quantity of terminal device groups shown in FIG. 3(b).

Further, a plurality of related terminal device groups in the sidelink communications system within the coverage of the network device may be divided into one zone, as shown in FIG. 3(c). The terminal device group #1 to a terminal device group #3 are three related terminal device groups in the sidelink communications system within the coverage of the network device, and a terminal device group #4 to a terminal device group #6 are three other related terminal device groups in the sidelink communications system within the coverage of the network device. Specifically, the terminal device group #1 to the terminal device group #3 are divided into a zone #1, and the terminal device group #4 to the terminal device group #6 are divided into a zone #2.

Terminal device groups in a same zone in the sidelink communications system within the coverage of the network device need to perform resource coordination with each other. However, interference between different zones is relatively small, and it may be understood that different zones have a specific degree of isolation. Optionally, the network device may determine, based on signal strength of a signal such as a reference signal received power (reference signal received power, RSRP)/reference signal received quality (reference signal received quality, RSRQ) reported by a terminal device, whether interference exists between terminal devices, and then coordinate resource allocation between terminal device groups having strong interference.

It should be understood that FIG. 3(c) is merely an example, and does not constitute any limitation on this application. For example, a quantity of zones in the sidelink communications system within the coverage of the network device may be greater than a quantity of zones shown in FIG. 3(c).

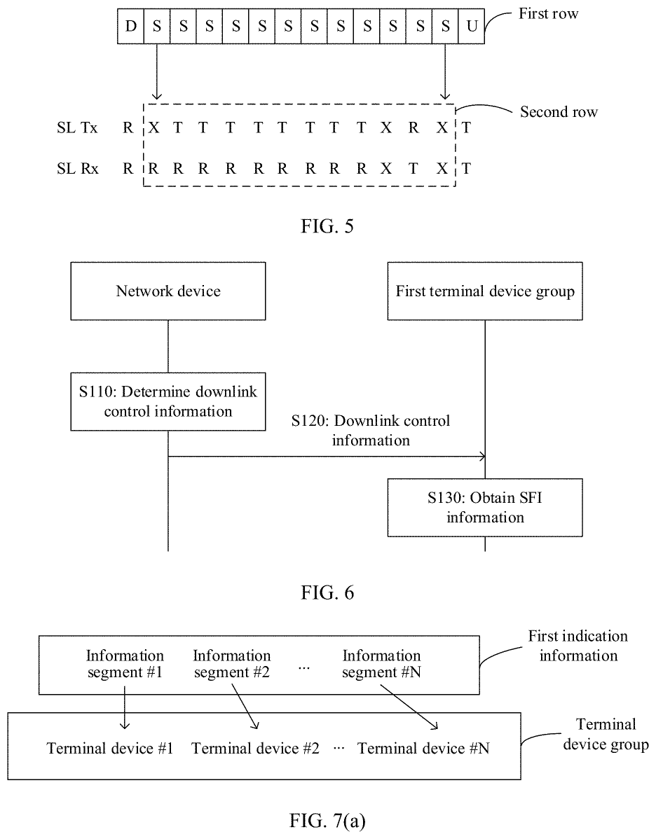

The foregoing briefly describes concepts of a slot format, a method for configuring a slot format by a network device in a 5G NR system, and a terminal device group in this application. Before the specific solutions of this application are described, a slot format configuration method for sidelink communication is provided. In the slot format configuration method, a symbol that can be used for sidelink communication in a slot is further determined based on the slot format indicator SFI in the 5G NR system. The slot format indication method for sidelink communication is briefly described below with reference to FIG. 4 and FIG. 5.

FIG. 4 is a schematic diagram of slot formats for sidelink communication. The schematic diagram includes a slot format shown in the first row and a slot format shown in the second row.

As shown in FIG. 4, the first row in FIG. 4 shows a slot format configured by a common SFI in 5G NR described above. D indicates that a transmission status of the symbol is a downlink transmission state, U indicates that the transmission status of the symbol is an uplink transmission state, and X indicates that the status of the symbol is an unknown state. As described above, the X symbol may also be referred to as a flexible (F) symbol or an unknown (U) symbol, and indicates that a transmission direction in the X symbol is variable or configurable.

The second row in FIG. 4 shows a symbol whose transmission status is X or U in a slot based on a slot format configuration of a common SFI in 5G NR, and further indicates that the transmission status of the symbol is a sidelink communication (sidelink, S) symbol.

When a slot format is configured as a sidelink communications slot format shown in the second row in FIG. 4, a sidelink communications slot format indicator (sidelink SFI, SL-SFI) may further indicate S_initial and S_end. S_initial refers to a start position of an S symbol, and S_end refers to an end position of the S symbol, so that an X symbol or a U symbol between S_initial and S_end is overwritten as an S symbol, and is used for sidelink communication.

In other words, the SFI in 5G NR may separately indicate D/X/U transmission states of a plurality of symbols included in one slot, and the SL-SFI in FIG. 4 may indicate the symbol S included in the slot. Based on resource scheduling of a network device or automatic resource selection of a terminal device, the symbol S may also be considered as an X symbol used for conversion between receiving and sending.

Further, as shown in FIG. 5, S may be further identified as an SL transmit (transmit, Tx) state or an SL receive (receive, Rx) state on a sidelink.

FIG. 5 is another schematic diagram of slot formats for sidelink communication. The schematic diagram includes a slot format shown in the first row and transmit and receive slot formats shown in the second row.

The slot format shown in the first row in FIG. 5 is the slot format shown in the second row in FIG. 4, that is, the middle 12 symbols are used for SL.

In the slot formats shown in the second row in FIG. 5, R identifies receiving, T identifies transmitting, and X identifies conversion between receiving and sending. In other words, the slot format method shown in FIG. 4 and FIG. 5 may indicate a slot format of a terminal device for sidelink communication. However, the method does not describe how to configure a slot format for a terminal device in a terminal device group in a sidelink communications system, and only a symbol that can be used for SL in the slot is further configured based on the slot format configured in 5G NR.

Specifically, in a V2X system, when groupcast communication is performed on a sidelink, a plurality of terminal devices may establish one terminal device group, and a sidelink communications system within the coverage of the network device may include a plurality of terminal device groups.

For example, the V2X system shown in FIG. 3(b) includes the terminal device #A to the terminal device #E, the terminal device #A to the terminal device #E form the terminal device group #1, the terminal device #A is a terminal device that sends information and that is in the terminal device group #1, and the terminal device #B to the terminal device #E are terminal devices that receive information and that are in the terminal device group #1. The terminal device #1 to the terminal device #5 form the terminal device group #2, the terminal device #1 is a terminal device that sends information and that is in the terminal device group #2, and the terminal device #2 to the terminal device #5 are terminal devices that receive information and that are in the terminal device group #2.

Specifically, a plurality of terminal devices in one terminal device group may be classified into an initiator terminal device (initiating user equipment, I UE) and a responder terminal device (reception user equipment, R UE) based on different terminal devices that perform information sending and information receiving.

It should be understood that one terminal device group includes only one initiator terminal device, and other terminal devices are all responder terminal devices. The plurality of terminal devices in the terminal device group are respectively referred to as the initiator terminal device and the responder terminal device for convenience only, but the protection scope of this application is not limited. For example, the initiator terminal device may also be referred to as a sender terminal device, an active terminal device, or the like. The responder terminal device may also be referred to as a receiver terminal device, a passive terminal device, or the like.

It should be further understood that the terminal device group in this application is not necessarily limited to the terminal device group in the V2X system, and a terminal device in another sidelink communications scenario also includes the foregoing terminal device group. Details are not described herein again.

Therefore, a plurality of terminal device groups exist in the V2X system. Therefore, for terminal devices separately included in the plurality of terminal device groups, SFI information needs to be sent to terminal devices in each terminal device group, and a slot format needs to be configured for each terminal device in the terminal device group, so that the terminal device in each terminal device group can learn of transmission statuses of a plurality of symbols included in one slot, to smoothly perform sidelink communication.

With reference to FIG. 6 to FIG. 12, the following describes in detail a sidelink communications method provided in this application. In the sidelink communications method, a network device can indicate a slot format of each terminal device in a terminal device group, so that each terminal device in the terminal device group learns of a time domain position at which each terminal device performs transmission and a time domain position at which each terminal device performs reception. In addition, information resources occupied when a slot format indicator is performed in the sidelink communications method in this embodiment of this application is small.

Specifically, the sidelink communications method can be applied to the foregoing V2V system or another sidelink communications scenario.

FIG. 6 is a schematic diagram of a sidelink communications method according to an embodiment of this application. The method is described in detail below.

S110: A network device determines downlink control information, where the downlink control information carries first indication information, and the first indication information is used to indicate a slot format corresponding to at least one terminal device group.

The network device determines, based on a total quantity of terminal device groups in a sidelink communications system within coverage of the network device, to configure slot formats for terminal devices in which terminal device groups in the system.

For example, a total quantity of terminal device groups in the sidelink communications system within the coverage of the network device is M, and the network device determines that slot formats need to be configured for terminal devices in N1 of the M terminal device groups by using the downlink control information. N1 is a positive integer, and M is an integer greater than or equal to N1.

Further, the network device determines, based on the N1 terminal device groups for which slot formats need to be configured and the terminal devices in the N1 terminal device groups, a load status of the downlink control information that needs to be sent.

Specifically, the downlink control information carries the first indication information, and the first indication information is used to indicate slot formats corresponding to the N1 terminal device groups. A terminal device group includes a plurality of terminal devices that perform sidelink groupcast communication.

It should be understood that a plurality of terminal devices that perform sidelink groupcast communication in one terminal device group include one initiator terminal device, configured to send information, and further include a plurality of responder terminal devices that are other than the initiator terminal device and that are configured to receive information sent by the initiator terminal device.

For example, if N1 is equal to 1,

that the first indication information is used to indicate slot formats corresponding to N1 terminal device groups includes:

the first indication information is used to indicate slot formats corresponding to N terminal devices in a first terminal device group, the first indication information includes N information segments, and one of the N information segments is used to indicate a slot format corresponding to one terminal device in the first terminal device group, where N is a positive integer. In other words, the network device configures the slot format for the terminal device in the first terminal device group by using the downlink control information, the N information segments are in a one-to-one correspondence with the N terminal devices in the first terminal device group, and the N information segments are respectively used to determine the slot formats of the N terminal devices. N is a positive integer less than or equal to a quantity of all terminal devices in the first terminal device group. In other words, the network device may configure slot formats for a part or all of terminal devices in the first terminal device group by using the downlink control information.

It should be understood that the first terminal device group may be any terminal device group in the sidelink communications system within the coverage of the network device, and “first” is merely used for distinguishing description, and should not constitute any limitation on this application.

For example, if N1 is greater than 1, the first indication information is used to indicate the slot formats corresponding to the N1 terminal device groups, the first indication information includes N1 information segments, and one of the N1 information segments is used to indicate a slot format corresponding to one of the N1 terminal device groups. In other words, the network device configures slot formats for the N1 terminal device groups by using the downlink control information. The N1 information segments are in a one-to-one correspondence with the N1 terminal device groups, and the N1 information segments are respectively used to determine the slot formats of the N1 terminal device groups. Resource coordination needs to be performed among the N1 terminal device groups, that is, the N1 terminal device groups are terminal device groups in a same zone.

Specifically, that resource coordination needs to be performed among the N1 terminal device groups includes: time domain resource coordination needs to be performed among the N1 terminal device groups, and/or frequency domain resource coordination needs to be performed among the N1 terminal device groups, and/or code domain resource coordination needs to be performed among the N1 terminal device groups.

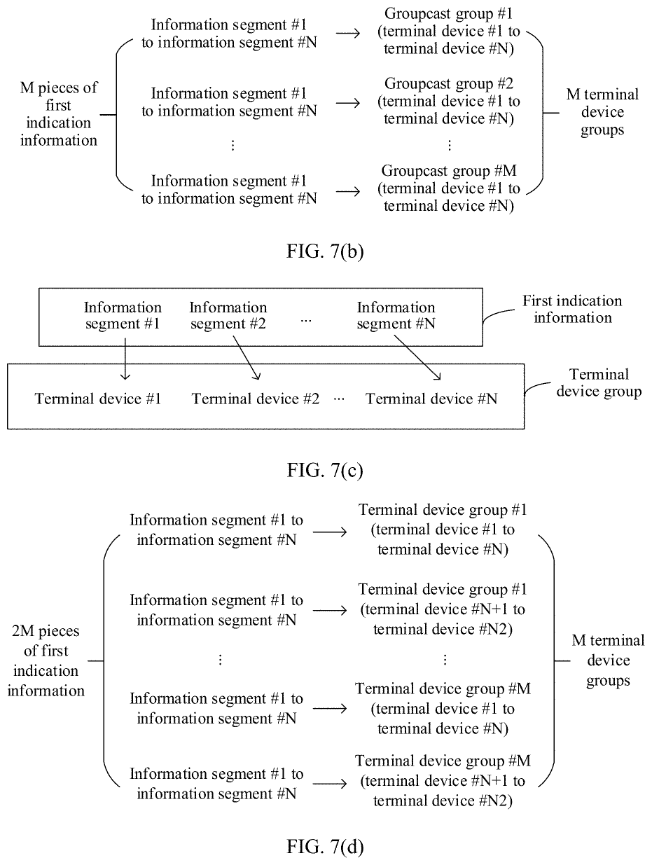

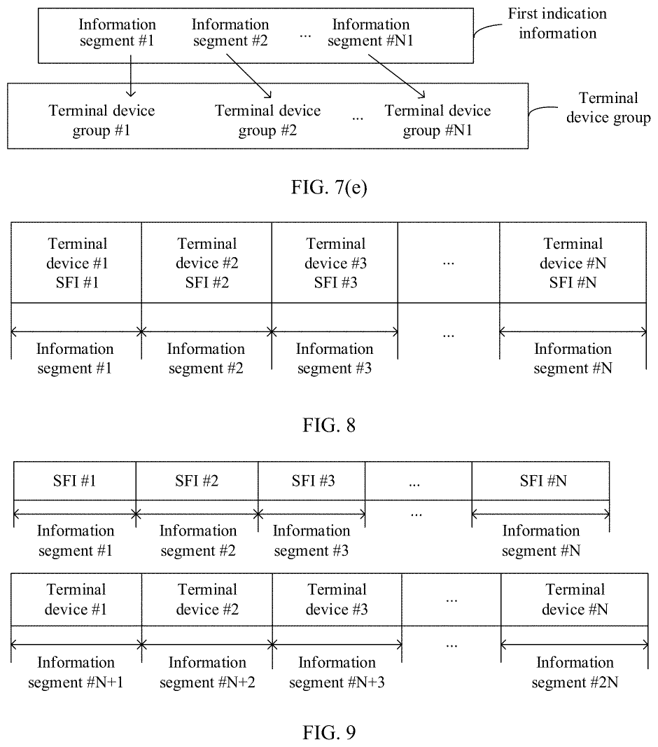

The following describes in detail several cases in which the N information segments correspond to the N1 terminal device groups with reference to FIG. 7. FIG. 7 is a schematic diagram indicating a correspondence between information segments and terminal device groups according to an embodiment of this application.

Case 1:

N1 is equal to 1, and a network device configures a slot format for a terminal device in a first terminal device group by using first indication information. The first terminal device group includes N terminal devices that perform sidelink groupcast communication. The first indication information includes N information segments, and the N information segments are in a one-to-one correspondence with the N terminal devices in the first terminal device group. As shown in FIG. 7(a), the first indication information carried in downlink control information includes N information segments (an information segment #1 to an information segment #N shown in FIG. 7(a)). Each information segment corresponds to one terminal device in a terminal device group (as shown in FIG. 7(a), the information segment #1 corresponds to a terminal device #1, the information segment #2 corresponds to a terminal device #2, . . . , and the information segment #N corresponds to a terminal device #N). Each information segment is used to determine a slot format of a terminal device corresponding to the information segment. That each information segment can determine the slot format of the terminal device corresponding to the information segment may be that each information segment includes slot format indicator information of the terminal device corresponding to the information segment, or each information segment corresponds to slot format indicator information of the terminal device corresponding to the information segment.

Specifically, in the case 1, if the network device needs to configure slot formats for terminal devices in M terminal device groups in a sidelink communications system within coverage of the network device, the network device needs to separately carry the M pieces of first indication information by using M pieces of downlink control information. Each piece of first indication information includes N information segments. The N information segments respectively correspond to N terminal devices included in one of the M terminal device groups (each of the M pieces of first indication information shown in FIG. 7(b) includes the information segment #1 to the information segment #N). Each information segment is used to determine a slot format of a terminal device in a terminal device group corresponding to the information segment.

It should be understood that, when the information segment shown in the case 1 corresponds to a terminal device group, one piece of first indication information can directly indicate slot formats corresponding to all terminal devices in one terminal device group. Therefore, when the sidelink communications system within the coverage of the network device includes M terminal device groups, the network device only needs to deliver M first messages, and carry the first indication information in each first message.

Case 2:

N1 is equal to 1, and a network device configures a slot format for a terminal device in a first terminal device group by using first indication information. In addition, the first terminal device group includes N2 terminal devices that perform sidelink groupcast communication. The first indication information includes N information segments, and the N information segments are in a one-to-one correspondence with N terminal devices in the first terminal device group, where N is a positive integer less than N2. As shown in FIG. 7(c), the first indication information carried in downlink control information includes N information segments (an information segment #1 to an information segment #N shown in FIG. 7(c)). Each information segment corresponds to one terminal device in a terminal device group (as shown in FIG. 7(c), the information segment #1 corresponds to a terminal device #1, the information segment #2 corresponds to a terminal device #2, . . . , and the information segment #N corresponds to a terminal device #N). Each information segment is used to determine a slot format of a terminal device corresponding to the information segment.

Specifically, in the case 2, assuming that N2=2N, the network device needs to configure, by using two pieces of downlink control information (downlink control information #1 and downlink control information #2), slot formats for N2 terminal devices included in the first terminal device group. N information segments included in the first indication information carried in the downlink control information #1 respectively correspond to the terminal device #1 to the terminal device #N in the terminal device group. N information segments included in the first indication information carried in the downlink control information #2 respectively correspond to a terminal device #N+1 to a terminal device #N2 in the terminal device group.

Further, if the network device configures slot formats for terminal devices in M terminal device groups in a sidelink communications system within coverage of the network device, the network device needs to separately carry the 2M pieces of first indication information by using 2M pieces of downlink control information. Each piece of first indication information includes N information segments. The N information segments respectively correspond to N terminal devices in one of the M terminal device groups (each of the 2M pieces of first indication information shown in FIG. 7(d) includes the information segment #1 to the information segment #N). Each information segment is used to determine a slot format of a terminal device in a terminal device group corresponding to the information segment.

It should be understood that (c) and (d) in FIG. 7 are only example forms. Specifically, N2 may alternatively be equal to 3N or another value. When a size of one piece of downlink control information is insufficient, a slot format of a terminal device in a terminal device group needs to be notified by using a plurality of pieces of downlink control information. Examples are not described one by one herein.

It should be understood that, when the information segment shown in the case 2 corresponds to a terminal device group, one piece of first indication information can directly indicate slot formats corresponding to a part of terminal devices in one terminal device group. Therefore, when the sidelink communications system within the coverage of the network device includes M terminal device groups, the network device needs to deliver M1 first messages, and carry the first indication information in each first message, where M1 is an integer greater than M. In this case, compared with the case 1, in the case 2, more first messages need to be delivered, and resource overheads of the network device are relatively high.

Case 3:

N1 is greater than 1, and a network device configures slot formats for N1 terminal device groups by using first indication information. As shown in FIG. 7(e), the first indication information carried in downlink control information includes N1 information segments (an information segment #1 to an information segment #N1 shown in FIG. 7(e)). Each information segment corresponds to one terminal device group (as shown in FIG. 7(e), the information segment #1 corresponds to a terminal device group #1, the information segment #2 corresponds to a terminal device group #2, . . . , and the information segment #N1 corresponds to a terminal device group #N1). Each information segment is used to determine a slot format of a terminal device group corresponding to the information segment.

The N1 information segments are in a one-to-one correspondence with the N1 terminal device groups, and resource coordination needs to be performed among the N1 terminal device groups. A plurality of related terminal device groups in the sidelink communications system within the coverage of the network device shown in FIG. 3(c) may be divided into one zone. It may be understood that the first indication information indicates slot formats of terminal devices in terminal device groups included in one zone.

It should be understood that, when the N1 information segments are in a one-to-one correspondence with the N1 terminal device groups, a second information segment in the N1 information segments indicates resources on which a terminal device in a second terminal device group corresponding to the second information segment performs transmission. However, the slot format of the terminal device in the second terminal device group is not specifically indicated. It may be understood that, the network device indicates, by using the second information segment, the slot format corresponding to an initiator terminal device in the second terminal device group, but the network device does not specify which terminal device in a plurality of terminal devices included in the second terminal device group is the initiator terminal device.

For example, for the second terminal device group, the second information segment corresponding to the second terminal device group indicates that a transmission resource of the terminal device in the second terminal device group is TTTXXXTT. For a third terminal device group, a third information segment corresponding to the third terminal device group indicates that a transmission resource of a terminal device in the third terminal device group is XXXTTTXXXXXTT. For a fourth terminal device group, a fourth information segment corresponding to the fourth terminal device group indicates that a transmission resource of a terminal device in the fourth terminal device group is XXXXXXXTTTTTXX. In addition, when notifying transmission resources of a plurality of terminal device groups in one zone, the network device performs resource coordination and allocation among the terminal device groups. The transmission resources among the second terminal device group, the third terminal device group, and the fourth terminal device group are completely orthogonally coordinated in terms of time resources, so as to avoid mutual interference. However, this is not limited in this application. For another example, the transmission resources among the second terminal device group, the third terminal device group, and the fourth terminal device group may be not completely orthogonally coordinated in terms of time resources.

It should be understood that, when the information segment shown in the case 3 corresponds to a terminal device group, one piece of first indication information can directly indicate slot formats corresponding to a plurality of terminal device groups. Therefore, when the sidelink communications system within the coverage of the network device includes N1 terminal device groups, the network device needs to deliver one first message, and carry the first indication information in the first message. In this case, compared with the case 1 and the case 2, in the case 3, fewer first messages need to be delivered, and resource overheads of the network device are relatively small.

Optionally, when learning of a slot format corresponding to one terminal device group to which a terminal device in the terminal device group belongs, the terminal device in the terminal device group may further learn of a transmission resource of another terminal device group that is in a same zone and with strong interference with the terminal device. Therefore, when a transmission status of a symbol included in a slot of the terminal device is determined, influence of a surrounding terminal device group can be considered.

Specifically, the downlink control information is the foregoing DCI, the first indication information is information used to indicate a slot format, and the DCI is used to carry slot format indicator information.

For example, for the foregoing case 1, the DCI includes the following information:

(1) a DCI format identifier, where the DCI format identifier may occupy one or more bits; and

(2) SFI information of the terminal device #1 in the terminal device group #1, SFI information of the terminal device #2 in the terminal device group #1, . . . , and SFI information of the terminal device #N in the terminal device group #1.

For example, for the foregoing case 2, the DCI includes the following information:

(1) a DCI format identifier, where the DCI format identifier may occupy one or more bits;

(2) an identifier of a start terminal device; and

(3) SFI information of the terminal device #1 in the terminal device group #1, SFI information of the terminal device #2 in the terminal device group #1, . . . , and SFI information of the terminal device #N in the terminal device group #1.

The identifier that is of the start terminal device and that is in the information included in the DCI is an item that needs to be added when a size of the DCI is insufficient. Details are described in the following with reference to a specific scenario, and details are not described herein again.

For another example, for the foregoing case 3, the DCI includes the following information:

(1) a DCI format identifier, where the DCI format identifier may occupy one or more bits; and

(2) SFI information of the terminal device group #1, SFI information of the terminal device group #2, . . . , and SFI information of the terminal device group #N1.

The SFI information of the terminal device group #1 is transmission resource indication information of all terminal devices in the terminal device group #1.

For example, the first indication information is slot format indicator information of terminal devices in the N1 terminal device groups, and the terminal devices in the terminal device groups perform sidelink communication. In this case, the first indication information may be referred to as sidelink communications slot format indicator (sidelink slot format indicator, SL-SFI) information.

For example, corresponding to the foregoing case 1 and case 2, the N information segments correspond to the N terminal devices, and the N information segments may be in a one-to-one correspondence with identifiers of the N terminal devices. Further, to make the N information segments in a one-to-one correspondence with the identifiers of the N terminal devices, the network device needs to determine a one-to-one correspondence between the N information segments and the identifiers of the N terminal devices, and send a second message to the N terminal devices. The second message includes the one-to-one correspondence between the N information segments and the identifiers of the N terminal devices. The second message may be semi-static signaling, or another message used to send a one-to-one correspondence between the N information segments and the N terminal devices.

For example, the second message may be RRC signaling, MAC signaling, or physical layer signaling. Alternatively, the second message may be any message that is determined by the network device and that is used to carry the one-to-one correspondence between the N information segments and the N terminal devices.

Alternatively, the one-to-one correspondence between the N information segments and the identifiers of the N terminal devices is preconfigured in the network device and/or the N terminal devices.

The one-to-one correspondence between the information segments and the identifiers of the terminal devices described herein may also be referred to as a one-to-one correspondence between positions of information including SFI information in the downlink control information and the identifiers of the terminal devices.

In other words, a terminal device can determine, based on an identifier of the terminal device, an information segment corresponding to the terminal device.

Specifically, that a terminal device can determine, based on an identifier of the terminal device, an information segment corresponding to the terminal device includes the following several manners:

Manner 1:

Each information segment in the first indication information includes an identifier of a terminal device, and the identifier indicates that each information segment includes SFI information of the terminal device indicated by the identifier of the terminal device.

FIG. 8 is a schematic diagram implementing a one-to-one correspondence between information segments and terminal devices according to an embodiment of this application. The schematic diagram includes an information segment #1 to an information segment #N, and each information segment includes an identifier of a terminal device (a terminal device #1 to a terminal device #N shown in FIG. 8) and SFI information (an SFI #1 to an SFI #N shown in FIG. 8) corresponding to the terminal device. That is, the identifier, of the terminal device, included in each information segment may indicate that SFI information of which terminal device is included in each information segment.

Specifically, FIG. 9 is another schematic diagram implementing a one-to-one correspondence between information segments and terminal devices according to an embodiment of this application. The schematic diagram includes an information segment #1 to an information segment #N, where each information segment includes SFI information (an SFI #1 to an SFI #N shown in FIG. 9) corresponding to a terminal device in a terminal device group, and the schematic diagram includes an information segment #N+1 to an information segment #2N, where each information segment includes identifiers of terminal devices (a terminal device #1 to a terminal device #N shown in FIG. 9) corresponding to the information segment #1 to the information segment #N. That is, a correspondence between an identifier of a terminal device and an information segment including SFI information of the terminal device may be established.

Optionally, a sequence of the information segment #1 to the information segment #N and the information segment #N+1 to the information segment #2N in FIG. 9 may be reversed. The information segment #1 to the information segment #N in FIG. 9 may also be referred to as a sub-information segment #1 to a sub-information segment #N in an information segment. The information segment #N+1 to the information segment #2N may also be referred to as a sub-information segment #N+1 to a sub-information segment #2N in an information segment.

Manner 2:

A sequence of identifiers of terminal devices corresponding to information segments in the first indication information is preset by only including SFIs corresponding to the terminal devices in the information segments, and the identifiers of the terminal devices do not need to be carried as shown in FIG. 8 and FIG. 9.

For example, it is preset that terminal devices are sorted in ascending order starting from an identifier 1, and the terminal device obtains, based on the identifier of the terminal device, an information segment corresponding to the identifier of the terminal device. A terminal device #1 is a terminal device whose identifier is 1, that is, the terminal device #1 obtains an information segment #1, and obtains SFI information of the terminal device #1 from the information segment #1. The identifier 1 of the terminal device may not need to be carried in the downlink control information, and the preset ascending order may be notified to N terminal devices by using semi-static signaling, or may be preconfigured in the network device and/or N terminal devices.

For another example, it is preset that terminal devices are sorted in descending order starting from an identifier N, and the terminal device correspondingly obtains an information segment based on the identifier of the terminal device. A terminal device #1 is a terminal device whose identifier is 1, that is, the terminal device #1 obtains an information segment #N, and obtains SFI information of the terminal device #N from the information segment #1. The identifier N of the terminal device may not need to be carried in the downlink control information, and the preset descending order may be notified to N terminal devices by using semi-static signaling, or may be preconfigured in the network device and/or N terminal devices.

For another example, it is preset that terminal devices are sorted in ascending order starting from an identifier P, and the terminal device correspondingly obtains an information segment based on the identifier of the terminal device. A terminal device #1 is a terminal device whose identifier is 1, that is, the terminal device #1 obtains an information segment #1, and obtains SFI information of the terminal device #1 from the information segment #1. The identifier P of the terminal device and the ascending order may be notified to N terminal devices by using semi-static signaling, or may be preconfigured in the network device and/or N terminal devices.

For another example, it is preset that terminal devices are sorted in descending order starting from an identifier P, and the terminal device correspondingly obtains an information segment based on the identifier of the terminal device. A terminal device #1 is a terminal device whose identifier is 1, that is, the terminal device #1 obtains an information segment #P, and obtains SFI information of the terminal device #1 from the information segment #P. The identifier P of the terminal device and the descending order may be notified to N terminal devices by using semi-static signaling, or may be preconfigured in the network device and/or N terminal devices.

For another example, a sequence of identifiers of terminal devices corresponding to information segments in the first indication information may be in a predefined order, or in a discontinuous ascending order, or in a discontinuous descending order. These may be used as examples, and are not enumerated one by one.

Manner 3:

The network device determines a one-to-one correspondence between identifiers of N terminal devices and N information segments, and notifies the N terminal devices of the one-to-one correspondence by using a second message, where the second message may be semi-static signaling. Alternatively, a one-to-one correspondence between identifiers of N terminal devices and N information segments is preconfigured in the network device and/or the N terminal devices. In this case, the terminal device can obtain, based on a one-to-one correspondence between an identifier of the terminal device and an information segment, the information segment corresponding to the identifier of the terminal device.

It should be understood that the foregoing identifier of the terminal device is a relative identifier of the terminal device in a terminal device group to which the terminal device belongs. For example, one terminal device group includes 16 terminal devices, and the 16 terminal devices are identified from 1 to 16.

For example, for the foregoing case 3, the N1 information segments correspond to the N1 terminal device groups, and the N1 information segments may be in a one-to-one correspondence with identifiers of the N1 terminal device groups. Further, to make the N1 information segments in a one-to-one correspondence with the identifiers of the N1 terminal device groups, a one-to-one correspondence between the N1 information segments and the identifiers of the N1 terminal device groups needs to be established. That is, an information segment corresponding to a terminal device group can be determined based on an identifier of the terminal device group.

Specifically, the information segment corresponding to the terminal device group can be determined based on the identifier of the terminal device group in the following several manners:

Manner 1:

Each information segment in the first indication information includes an identifier of a terminal device group, and the identifier indicates that each information segment includes SFI information of the terminal device group indicated by the identifier of the terminal device group.

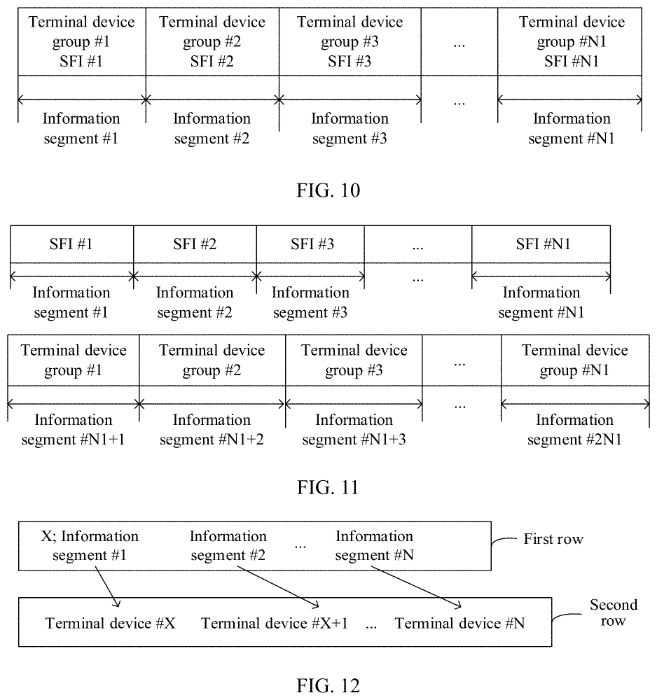

FIG. 10 is a schematic diagram implementing a one-to-one correspondence between information segments and terminal device groups according to an embodiment of this application. The schematic diagram includes an information segment #1 to an information segment #N1, and each information segment includes an identifier of a corresponding terminal device group (a terminal device group #1 to a terminal device group #N1 shown in FIG. 10) and SFI information (an SFI #1 to an SFI #N1 shown in FIG. 10) corresponding to the terminal device group. That is, the identifier, of the corresponding terminal device, included in each information segment may indicate that SFI information of which terminal device group is included in each information segment.

Specifically, FIG. 11 is another schematic diagram implementing a one-to-one correspondence between information segments and terminal device groups according to an embodiment of this application. The schematic diagram includes an information segment #1 to an information segment #N1, where each information segment includes SFI information (an SFI #1 to an SFI #N1 shown in FIG. 11) corresponding to a terminal device group, and the schematic diagram includes an information segment #N1+1 to an information segment #2N1, where each information segment includes identifiers of terminal device groups corresponding to the information segment #1 to the information segment #N1. That is, a correspondence between an identifier of a terminal device group and an information segment including SFI information of the terminal device group may be established.

Optionally, a sequence of the information segment #1 to the information segment #N1 and the information segment #N1+1 to the information segment #2N1 in FIG. 11 may be reversed. The information segment #1 to the information segment #N1 in FIG. 11 may also be referred to as a sub-information segment #1 to a sub-information segment #N1 in an information segment. The information segment #N1+1 to the information segment #2N1 may also be referred to as a sub-information segment #N1+1 to a sub-information segment #2N1 in an information segment.

Manner 2:

A sequence of identifiers of terminal device groups corresponding to information segments in the first indication information is preset by only including SFIs corresponding to the terminal device groups in the information segments, and the identifiers of the terminal device groups do not need to be carried as shown in FIG. 10 and FIG. 11.

For example, it is preset that terminal device groups are sorted in ascending order starting from an identifier 1, and a terminal device in a terminal device group correspondingly obtains an information segment based on an identifier of the terminal device group to which the terminal device belongs. A terminal device group #1 is a terminal device group whose identifier is 1, that is, a terminal device in the terminal device group #1 obtains an information segment #1, first obtains SFI information of the terminal device group #1 from the information segment #1, and then determines an SFI of the terminal device based on an automatic detection result or resource allocation. The identifier 1 of the terminal device group may not need to be carried in the downlink control information, and the preset ascending order may be notified to terminal devices in N1 terminal device groups by using semi-static signaling, or may be preconfigured in the network device and/or terminal devices in N1 terminal device groups.

For another example, it is preset that terminal device groups are sorted in descending order starting from an identifier N1, and a terminal device in a terminal device group correspondingly obtains an information segment based on an identifier of the terminal device group to which the terminal device belongs. A terminal device group #1 is a terminal device group whose identifier is 1, that is, a terminal device in the terminal device group #1 obtains an information segment #N1, first obtains SFI information of the terminal device group #1 from the information segment #N1, and then determines an SFI of the terminal device based on an automatic detection result or resource allocation. The identifier N1 of the terminal device group may not need to be carried in the downlink control information, and the preset descending order may be notified to terminal devices in N1 terminal device groups by using semi-static signaling, or may be preconfigured in the network device and/or terminal devices in N1 terminal device groups.

For another example, it is preset that terminal device groups are sorted in ascending order starting from an identifier P, and a terminal device in a terminal device group correspondingly obtains an information segment based on an identifier of the terminal device group to which the terminal device belongs. A terminal device group #1 is a terminal device group whose identifier is 1, that is, a terminal device in the terminal device group #1 obtains an information segment #1, first obtains SFI information of the terminal device group #1 from the information segment #1, and then determines an SFI of the terminal device based on an automatic detection result or resource allocation. The identifier P of the terminal device group and the ascending order may be notified to terminal devices in N1 terminal device groups by using semi-static signaling, or may be preconfigured in the network device and/or terminal devices in N1 terminal device groups.

For another example, it is preset that terminal device groups are sorted in descending order starting from an identifier P, and a terminal device in a terminal device group correspondingly obtains an information segment based on an identifier of the terminal device group to which the terminal device belongs. A terminal device group #1 is a terminal device group whose identifier is 1, that is, a terminal device in the terminal device group #1 obtains an information segment #P, first obtains SFI information of the terminal device group #1 from the information segment #P, and then determines an SFI of the terminal device based on an automatic detection result or resource allocation. The identifier P of the terminal device group and the descending order may be notified to terminal devices in N1 terminal device groups by using semi-static signaling, or may be preconfigured in the network device and/or terminal devices in N1 terminal device groups.

For another example, a sequence of identifiers of terminal device groups corresponding to information segments in the first indication information may be in a predefined order, or in a discontinuous ascending order, or in a discontinuous descending order. These may be used as examples, and are not enumerated one by one.

Manner 3:

The network device determines a one-to-one correspondence between identifiers of N1 terminal device groups and N1 information segments, and notifies terminal devices in the N1 terminal device groups of the one-to-one correspondence by using a third message, where the third message may be semi-static signaling. Alternatively, a one-to-one correspondence between identifiers of N1 terminal device groups and N1 information segments is preconfigured in the network device and/or terminal devices in the N1 terminal device groups. In this case, the terminal device can obtain, based on a one-to-one correspondence between an identifier of a terminal device group to which the terminal device belongs and an information segment, the information segment corresponding to the identifier of the terminal device group, and further obtain SFI information of the terminal device.

After determining the downlink control information, the network device sends the downlink control information to a terminal device group for which a slot format needs to be configured, and S120 is performed.

In this embodiment of this application, the network device may perform signaling interaction with a terminal device in at least one terminal device group, to configure a slot format. Without loss of generality, the sidelink communications method provided in this embodiment of this application is described in detail below by using signaling interaction between a network device and a terminal device in a first terminal device group as an example.

It should be understood that the first terminal device group may be any one of the at least one terminal device group, “first” is merely used for distinguishing description, and should not constitute any limitation on this application.

S120: The network device sends the downlink control information to the first terminal device group.

For example, for the foregoing case 1 and case 2, the network device sends the downlink control information to the terminal device in the first terminal device group, where the downlink control information carries the first indication information, and the first indication information includes N information segments. The N information segments are in a one-to-one correspondence with the N terminal devices in the first terminal device group, and the N information segments respectively include slot format indicator SFI information corresponding to the N terminal devices. The first terminal device group is any one of a plurality of terminal device groups for which slot formats need to be configured.

For example, for the foregoing case 3, the network device sends the downlink control information to the terminal device in the first terminal device group in the N1 terminal device groups, where the downlink control information carries the first indication information, and the first indication information includes N1 information segments. The N1 information segments are in a one-to-one correspondence with the N1 terminal device groups, and the N1 information segments respectively include slot format indicator SFI information corresponding to the N1 terminal device groups.

For example, SFI information included in each information segment may be a table that is preconfigured by using RRC signaling and that is used to determine an SFI. The table includes a correspondence between an SFI index and an actual transmission status (a sending state, a receiving state, or an unknown state) of a symbol. Therefore, SFI information included in the information segment is each SFI index. The table used to determine the SFI is a terminal device-specific slot format combination table configured for the sidelink.

For example, the SFI information included in each information segment may alternatively be a bitmap of a preset length. The preset length may be notified by the network device to a terminal device in a terminal device group by using the RRC signaling. Alternatively, the preset length may be preset in the network device and the terminal device. The bitmap of the preset length represents an indication for distinguishing an actual transmission status (a sending state, a receiving state, or an unknown state) of a symbol within a specific time range starting from a first moment. Therefore, SFI information included in the information segment is each SFI bitmap.

For example, before sending the downlink control information, the network device scrambles the downlink control information. Specifically, the network device defines a first identifier, and the downlink control information is scrambled by using the first identifier.

For example, for the foregoing case 1 and case 2, the first identifier is predefined by the network device. The network device notifies the N terminal devices in the terminal device group by using the semi-static signaling, so that all the N terminal devices can learn of the first identifier in advance. Alternatively, the first identifier is preconfigured, and the preconfiguration means that the first identifier is preset in the network device and/or the N terminal devices.

Optionally, in the foregoing case 1 and case 2, different pieces of downlink control information sent by the network device for different terminal device groups are scrambled by using different first identifiers.

For example, each piece of downlink control information that carries the first indication information may be scrambled by using a terminal device group radio network temporary identifier (radio network temporary identifier, RNTI) corresponding to a terminal device group, to which the terminal device belongs, corresponding to the information segment included in the first indication information, where the terminal device group RNTI may also be referred to as a group-RNTI.

Optionally, in the foregoing case 1 and case 2, different pieces of downlink control information sent by the network device for different terminal device groups may be scrambled by using a same first identifier.

For example, the network device defines a common first identifier for a plurality of terminal device groups. Further, the plurality of terminal device groups are distinguished by using a position offset or a time offset. In this way, a quantity of first identifiers required for scrambling can be reduced. The position offset refers to an offset in a frequency domain position of sending control information in a first search space, and the time offset refers to an offset in a time of sending the control information in the first search space.

The following uses an example to describe a solution in which a plurality of pieces of downlink control information are scrambled by using a same first identifier.

Slot formats need to be configured for a total of 30 terminal device groups in the sidelink communications system within the coverage of the network device, and the network device separately delivers downlink control information to terminal devices in each terminal device group. That is, the network device separately delivers downlink control information #1 to downlink control information #30 for a terminal device group #1 to a terminal device group #30. The downlink control information #1 to the downlink control information #5 are scrambled by using a first identifier #1, the downlink control information #6 to the downlink control information #10 are scrambled by using the first identifier #1, . . . , and the downlink control information #26 to downlink control information #30 are scrambled by using a first identifier #6. In this way, for 30 different pieces of downlink control information delivered by 30 terminal device groups, a quantity of required first identifiers used to scramble downlink control information is reduced from 30 to 6.

Further, when the downlink control information #1 to the downlink control information #5 are scrambled by using the first identifier #1, the terminal device group #1 to the terminal device group #5 may be distinguished by using the position offset or the time offset.

For example, based on a reference frequency domain resource, for the downlink control information #1, a position offset is 0; for the downlink control information #2, a position offset is 1; . . . ; and for the downlink control information #5, a position offset is 4. Therefore, based on the downlink control information that includes the first indication information and that is detected on different position offsets, the terminal device may learn of which group the first indication information corresponds to, so as to correctly configure slot formats of the terminal devices in the plurality of terminal device groups while reducing a quantity of required first identifiers.

For another example, based on a reference time domain resource, for the downlink control information #1, a time domain offset is 0; for the downlink control information #2, a time domain offset is 1; . . . ; and for the downlink control information #5, a time domain offset is 4. Therefore, based on the downlink control information that includes the first indication information and that is detected on different time domain offsets, the terminal device may learn of which group the first indication information corresponds to, so as to correctly configure slot formats of the terminal devices in the plurality of terminal device groups while reducing a quantity of required first identifiers.

Certainly, the downlink control information may also be indicated jointly with reference to the position offset and the time offset. The method is similar and will not be described in detail.

For example, for the foregoing case 3, the first identifier is predefined by the network device. The network device notifies the terminal devices in the N1 terminal device groups by using semi-static signaling, so that the terminal devices in the N1 terminal device groups can learn of the first identifier in advance. Alternatively, the first identifier is preconfigured, and the preconfiguration means that the first identifier is preset in the network device and/or the terminal devices in the N1 terminal device groups.

For example, the network device configures slot formats of terminal devices included in N1 terminal device groups in one zone, and may define a zone RNTI for the zone. The zone RNTI may also be referred to as a zone-RNTI. The downlink control information that carries the first indication information may be scrambled by using a predefined zone RNTI.

It should be understood that scrambling the downlink control information in this application means scrambling a cyclic redundancy check (cyclic redundancy check, CRC) part in the downlink control information.

Further, to simplify search by the terminal device for SFI information, the network device defines a first search space of an SL, and sends third indication information to the terminal devices in the N1 terminal device groups, where the third indication information is used to indicate the first search space. The third indication information may be semi-static signaling. A control resource set (control resource set, CORSET) may be further configured to detect an SL-specific SFI. For example, fourth indication information is sent to the terminal devices in the N1 terminal device groups, where the fourth indication information is used to indicate the CORSET. A control channel element (control channel element, CCE) in one CORSET or in different CORSETs may be further configured to detect SFIs of different terminal device groups.

For example, for the foregoing case 2, due to a load limitation of the downlink control information, SFI information of all terminal devices included in a terminal device group cannot be carried in the downlink control information, and the downlink control information further includes second indication information, where the second indication information is used to identify the N terminal devices. In other words, the downlink control information includes second indication information that can determine to configure slot formats for which terminal devices in the terminal device group.

Optionally, the second indication information may be an identifier that includes each of the N terminal devices and that is shown in FIG. 8 and FIG. 9.

Optionally, the second indication information may indicate, by using a position offset or a time offset, an identifier of a terminal device that can be indicated.

For example, when there are 30 terminal devices (a terminal device #1 to a terminal device #30) in a terminal device group, one piece of downlink control information may carry slot format indicator information of a maximum of 16 terminal devices. In this case, a first part of the 30 terminal devices, that is, slot format indicator information corresponding to 1 to 16 terminal devices, may be detected when the position offset is 1, and a second part of the 30 terminal devices, that is, slot format indicator information corresponding to 17 to 30 terminal devices, may be detected when the position offset is 2.

Similarly, different detection time domain offsets may be defined, so that the first part and the second part of the 30 terminal devices are separately detected. For example, the first part of the 30 terminal devices, that is, the slot format indicator information corresponding to 1 to 16 terminal devices, is detected when the time domain offset is 1, and the second part of the 30 terminal devices, that is, the slot format indicator information corresponding to 17 to 30 terminal devices, is detected when the time domain offset is 2.

Similarly, more different parts of slot format indicator information may be obtained with reference to the detected position offset and the time domain offset. The method is similar and will not be described in detail.

For example, the second indication information includes an identifier of a start terminal device in the N terminal devices. In other words, the second indication information is adding an additional field to the downlink control information to indicate the N terminal devices.

The field is used to indicate an identifier that is of the start terminal device in the N terminal devices and that can be indicated by the downlink control information, that is, the first indication information carried in the downlink control information can indicate slot formats of a series of terminal devices or a range of terminal devices starting from an index of the terminal device indicated by the field.

It should be understood that, for one terminal device group, identifiers of a plurality of terminal devices included in the terminal device group and an order of identifier sizes of different terminal devices are known to both the network device and the terminal device. In this case, only the identifier of the start terminal device in the N terminal devices may be indicated, and the N terminal devices are determined based on the identifier of the start terminal device in a known order.

FIG. 12 is a schematic diagram of a format of second indication information according to this application. The schematic diagram includes a first row and a second row, where the first row represents downlink control information, and the second row represents terminal devices in a terminal device group corresponding to an information segment included in first indication information carried in the downlink control information. Specifically, one bit X is added to the downlink control information, to indicate that the first indication information included in the downlink control information starts to configure a slot format from the X^{th} terminal device identified as X.

For example, when X=9, it indicates that the first indication information included in the downlink control information starts to configure a slot format from the ninth terminal device. Therefore, a first information segment in the first indication information includes SFI information of the ninth terminal device, a second information segment includes SFI information of the tenth terminal device, and so on.

Similarly, for the foregoing case 3, due to a load limitation of the downlink control information, slot format information corresponding to all terminal device groups in the sidelink communications system within the coverage of the network device cannot all be carried in one piece of downlink control information. In this case, the downlink control information further includes fourth indication information, and the fourth indication information is used to identify the N1 terminal device groups. In other words, the downlink control information includes fourth indication information that can determine to configure slot formats for which terminal device groups.

Specifically, the fourth indication information is similar to the foregoing second indication information, and details are not described herein again.

S130: The terminal device obtains the SFI information.

For example, for the case 1 and the case 2, the network device sends downlink control information to terminal devices in the first terminal device group, and scrambles the downlink control information by using the first identifier. An example in which the first terminal device in the terminal device group obtains corresponding SFI information is used for description.

The first terminal device is any one of the N terminal devices in the terminal device group.

It should be understood that “first” and “second” are merely used to distinguish different terminal devices, and constitute no limitation on this application.

For example, the first information segment included in the first indication information carried in the downlink control information includes SFI information of the first terminal device, and the first terminal device obtains, based on a one-to-one correspondence between an identifier of the first terminal device and the first information segment, the first information segment corresponding to the first terminal device, and further obtains the SFI information included in the first information segment.

It should be understood that SFI information included in different information segments may indicate different slot formats.

For example, for the case 3, the network device sends downlink control information to terminal devices in N1 terminal device groups, and scrambles the downlink control information by using the first identifier. An example in which the first terminal device group in the N1 terminal device groups obtains corresponding SFI information is used for description.

For example, the first information segment included in the first indication information carried in the downlink control information includes SFI information of the first terminal device group, and the first terminal device group obtains, based on a one-to-one correspondence between an identifier of the first terminal device group and the first information segment, the first information segment corresponding to the first terminal device group, and further obtains the SFI information included in the first information segment. The SFI information of the first terminal device group indicates a slot format corresponding to a terminal device that sends information and that is in the first terminal device group. It may be understood that the SFI information of the first terminal device group indicates a slot format of a terminal device that sends information and that is in the first terminal device group. However, a terminal device in the first terminal device group is not specified as a terminal device that sends information.

Further, after the terminal device in the first terminal device group obtains the first information segment, the terminal device in the first terminal device group starts a transmission manner of automatic detection to detect, in the slot format indicated by the SFI information of the first terminal device group, a resource that can be transmitted, and determines respective slot formats based on a detection result, that is, different terminal devices in the first terminal device group strive to perform transmission in the slot format indicated by SFI information in an equal competition relationship.

Alternatively, a master terminal device is disposed in the first terminal device group, and the master terminal device allocates resources based on a slot format indicated by the obtained SFI information included in the first information segment, and allocates resources to different terminal devices in the first terminal device group. The master terminal device may be referred to as a group leader (group leader) in the first terminal device group.

For example, when obtaining the SFI information in the first information segment, the first terminal device group may further obtain SFI information of another terminal device group in a same zone. That is, the first terminal device group can obtain the SFI information of the terminal device group corresponding to the information segment included in the first indication information carried in the downlink control information. That is, when the first terminal device group learns of the SFI information of the first terminal device group, the first terminal device group can also learn of SFI information of a terminal device group that interferes strongly with the first terminal device group. Therefore, when determining transmission statuses of different terminal devices in the first terminal device group, impact of a terminal device group with strong interference can be considered.

The one-to-one correspondence described above may also be referred to as a matching relationship (matching relationship), an association (association), or the like. Specifically, the semi-static signaling or the preset configuration information in the foregoing description may be at least one of RRC signaling, media access control (media access control, MAC) signaling, or physical layer signaling.

The sidelink communications method provided in this application is described in detail above with reference to FIG. 6 to FIG. 12. The following briefly describes, with reference to specific embodiments, use procedures of the sidelink communications method provided in this application in different sidelink groupcast scenarios.

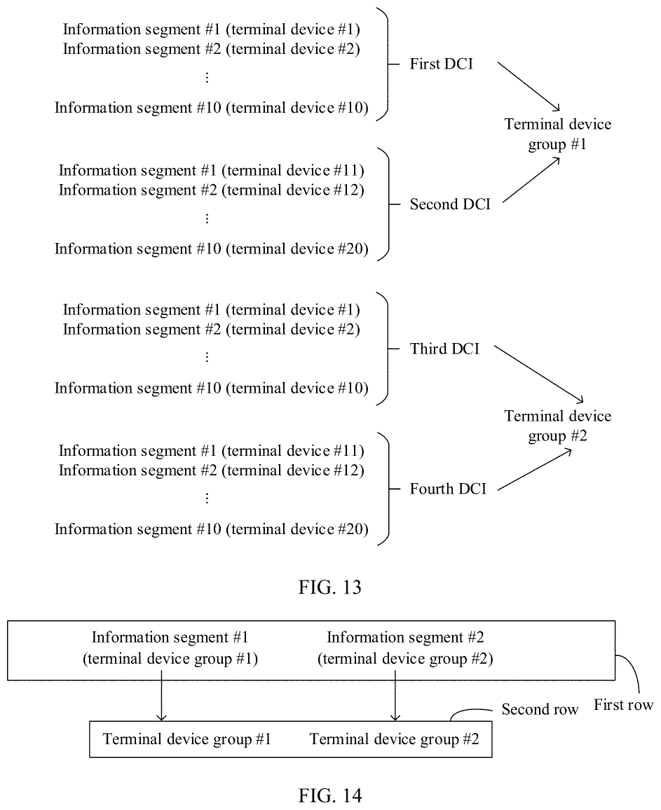

FIG. 13 is a schematic diagram indicating a slot format according to this application. The schematic diagram includes a left part and a right part, where the left part includes different DCI, and the right part includes different terminal device groups.

It is assumed that there are a total of two terminal device groups in a sidelink communications system within coverage of a network device, identifiers of the two terminal device groups are a group #1 and a group #2 respectively, and each terminal device group includes 20 terminal devices. Identifiers of the 20 terminal devices are a terminal device #1 to a terminal device #20 respectively. Due to a limitation of a size of the DCI, one piece of DCI can indicate only SFI information corresponding to 10 terminal devices in a terminal device group, that is, slot format joint indication information carried in the DCI includes only 10 information segments: an information segment #1 to an information segment #10. The 10 information segments are in a one-to-one correspondence with the 10 terminal devices.

In this case, to configure the slot formats of the terminal devices in the two terminal device groups, the network device delivers two pieces of DCI to each terminal device group. Each piece of DCI includes 10 information segments, which are respectively used to indicate SFI information of 10 terminal devices in one terminal device group.

For example, two pieces of DCI (first DCI and second DCI shown in FIG. 13) are delivered for the group #1. The first DCI indicates slot formats of the terminal device #1 to the terminal device #10 in the group #1, and the first DCI indicates slot formats of the terminal device #11 to the terminal device #20 in the group #1. Specifically, the second DCI needs to carry an indicated identifier of a start terminal device (the terminal device #11).

First, the network device scrambles, by using group-RNTIs of the two terminal device groups, DCI corresponding to the two terminal device groups. In this case, when receiving the corresponding DCI, the terminal device in each group of groupcast can parse the DCI based on the group-RNTI.

Then, for each terminal device group and each piece of DCI, the network device determines a one-to-one correspondence between 10 information segments and identifiers of 10 terminal devices, and notifies the 10 terminal devices of the one-to-one correspondence by using semi-static signaling. In this case, when receiving the DCI, the 10 terminal devices can obtain corresponding information segments based on the one-to-one correspondence and identifiers of the terminal devices. The identifier of the terminal device is a relative identifier of the terminal device in a terminal device group to which the terminal device belongs.

As shown in FIG. 13, the second DCI includes the following information:

(1) a DCI format identifier, where the DCI format identifier may occupy one or more bits;

(2) an identifier of a start terminal device: an identifier pair #11 of the eleventh terminal device in the terminal device group; and

(3) an information segment #1 (SFI information corresponding to the terminal device #11), an information segment #2 (SFI information corresponding to the terminal device #12), . . . , and an information segment #10 (SFI information corresponding to the terminal device #20).

FIG. 14 is another schematic diagram indicating a slot format according to this application. The schematic diagram includes a first row and a second row, where the first row includes DCI, and the second row includes different terminal device groups.

It is assumed that there are a total of two terminal device groups in a sidelink communications system within coverage of a network device, identifiers of the two terminal device groups are a group #1 and a group #2 respectively, and each terminal device group includes 20 terminal devices. Identifiers of the 20 terminal devices are a terminal device #1 to a terminal device #20 respectively. The DCI includes two information segments that are respectively corresponding to two terminal device groups, and are used to indicate slot formats corresponding to the terminal device groups.

First, the network device defines an RNTI for scrambling the DCI, and the RNTI is notified to the terminal device by using semi-static signaling. When receiving the DCI, the terminal device can parse the DCI based on the RNTI.

Then, the network device determines a one-to-one correspondence between two information segments and identifiers of two terminal device groups, and notifies the terminal device of the one-to-one correspondence by using semi-static signaling. In this case, when receiving the DCI, a terminal device group can obtain a corresponding information segment based on the one-to-one correspondence and an identifier of the terminal device group.

As shown in FIG. 14, the DCI includes the following information:

(1) a DCI format identifier, where the DCI format identifier may occupy one or more bits; and

(2) an information segment #1 (SFI information of the group #1) and an information segment #2 (SFI information of the group #2).

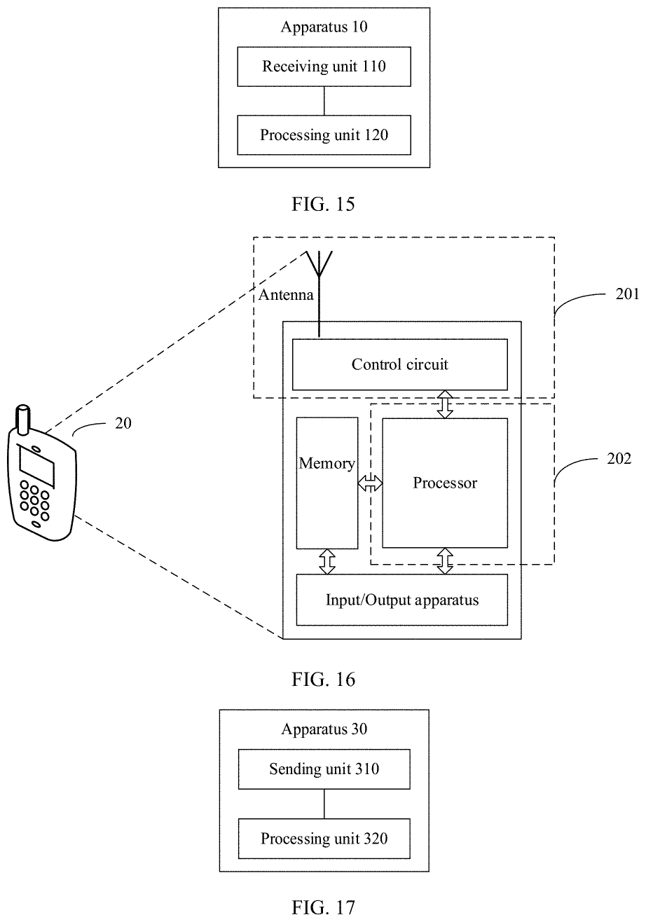

The sidelink communications method provided in the embodiments of this application is described above in detail with reference to FIG. 6 to FIG. 14. The following describes in detail a sidelink communications apparatus provided in the embodiments of this application with reference to FIG. 15 to FIG. 18.

FIG. 15 is a schematic diagram of a sidelink communications apparatus 10 according to this application. As shown in FIG. 15, the apparatus 10 includes a receiving unit 110 and a processing unit 120.

The receiving unit 110 is configured to receive downlink control information sent by a network device, where the downlink control information carries first indication information, the first indication information is used to indicate slot formats corresponding to N1 terminal device groups, and one terminal device group includes a plurality of terminal devices that perform sidelink groupcast communication, where N1 is a positive integer.

The processing unit 120 is configured to parse the downlink control information.

The apparatus 10 completely corresponds to the terminal device in the method embodiment, and a corresponding unit in the apparatus 10 is configured to perform a corresponding step performed by the terminal device in the method embodiment shown in FIG. 6.

The receiving unit 110 in the apparatus 10 performs the step of receiving in the method embodiment, for example, performs downlink control information receiving from the network device in FIG. 6. The processing unit 120 performs the step implemented or processed internally by the terminal device in the method embodiment, for example, performs downlink control information parsing in FIG. 6.

Optionally, the apparatus 10 may further include a sending unit 130, configured to send information to another device. The receiving unit 110 and the sending unit 130 may form a transceiver unit that has both receiving and sending functions. The processing unit 120 may be a processor. The receiving unit 110 may be a receiver. The sending unit 130 may be a transmitter. The receiver and the transmitter may be integrated to form a transceiver.

FIG. 16 is a schematic structural diagram of a terminal device 20 to which an embodiment of this application is applicable. The terminal device 20 may be applied to the system shown in FIG. 1. For ease of description, FIG. 16 shows only main components of the terminal device. As shown in FIG. 16, the terminal device 20 includes a processor, a memory, a control circuit, an antenna, and an input/output apparatus. The processor is configured to control the antenna and the input/output apparatus to send or receive a signal. The memory is configured to store a computer program. The processor is configured to invoke the computer program from the memory and run the computer program, to perform a corresponding procedure and/or operation performed by the terminal device in the sidelink communications method provided in this application. Details are not described herein again.

A person skilled in the art may understand that for ease of description, FIG. 16 shows only one memory and one processor. An actual terminal device may have a plurality of processors and a plurality of memories. The memory may also be referred to as a storage medium, a storage device, or the like. This is not limited in the embodiments of this application.

FIG. 17 is a schematic diagram of a sidelink communications apparatus 30 according to this application. As shown in FIG. 17, the apparatus 30 includes a sending unit 310 and a processing unit 320.

The processing unit 320 is configured to determine downlink control information, where the downlink control information carries first indication information, the first indication information is used to indicate slot formats corresponding to N1 terminal device groups, and one terminal device group includes a plurality of terminal devices that perform sidelink groupcast communication, where N1 is a positive integer.

The sending unit 310 is configured to send the downlink control information.

The apparatus 30 completely corresponds to the network device in the method embodiment, and a corresponding unit in the apparatus 30 is configured to perform a corresponding step performed by the network device in the method embodiment shown in FIG. 6.

The sending unit 310 in the apparatus 30 performs the step of sending by the network device in the method embodiment, for example, performs step 120 of sending the downlink control information to the terminal device in FIG. 6. The processing unit 120 performs the step implemented or processed internally by the network device in the method embodiment, for example, performs step 110 of determining the downlink control information in FIG. 6.

Optionally, the apparatus 30 may further include a receiving unit 330, configured to receive information sent by another device. The receiving unit 330 and the sending unit 310 may form a transceiver unit that has both receiving and sending functions. The processing unit 320 may be a processor. The sending unit 310 may be a receiver. The receiving unit 330 may be a transmitter. The receiver and the transmitter may be integrated to form a transceiver.

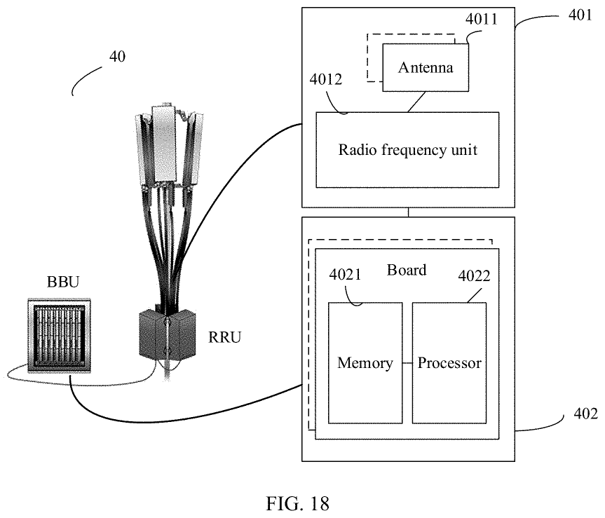

FIG. 18 is a schematic structural diagram of a network device 40 to which an embodiment of this application is applicable, and may be configured to implement functions of the network device in the sidelink communications method, for example, may be a schematic structural diagram of a base station. As shown in FIG. 18, the network device may be applied the system shown in FIG. 1.

The network device 40 may include one or more radio frequency units, for example, a remote radio unit (remote radio unit, RRU) 401 and one or more baseband units (base band unit, BBU). The baseband unit may also be referred to as a digital unit (digital unit, DU) 402. The RRU 401 may be referred to as a transceiver unit, and corresponds to the sending unit 310 in FIG. 17. Optionally, the transceiver unit 401 may also be referred to as a transceiver machine, a transceiver circuit, a transceiver, or the like, and may include at least one antenna 4011 and a radio frequency unit 4012. Optionally, the transceiver unit 401 may include a receiving unit and a sending unit. The receiving unit may correspond to a receiver (or referred to as a receiver machine or a receiver circuit), and the sending unit may correspond to a transmitter (or referred to as a transmitter machine or a transmitter circuit). The RRU 401 part is mainly configured to perform sending and receiving of a radio frequency signal and conversion between a radio frequency signal and a baseband signal, for example, configured to send the control information in the foregoing embodiments to a terminal device. The BBU 402 part is mainly configured to perform baseband processing, control the base station, and the like. The RRU 401 and the BBU 402 may be physically disposed together, or may be physically separated, that is, in a distributed base station.

The BBU 402 is a control center of the network device, may also be referred to as a processing unit, may correspond to the processing unit 320 in FIG. 17, and is mainly configured to complete a baseband processing function, such as channel coding, multiplexing, modulation, and spreading. For example, the BBU (processing unit) 402 may be configured to control the network device 40 to perform an operation procedure related to the network device in the foregoing method embodiments, for example, determine a length of a symbol that carries control information of the terminal device.

In an example, the BBU 402 may include one or more boards, and a plurality of boards may jointly support a radio access network (such as an LTE system or a 5G system) of a single access standard, or may separately support radio access networks of different access standards. The BBU 402 further includes a memory 4021 and a processor 4022. The memory 4021 is configured to store a necessary instruction and data. For example, the memory 4021 stores the codebook and the like in the foregoing embodiments. The processor 4022 is configured to control the base station to perform a necessary action, for example, is configured to control the base station to execute an operation procedure related to the network device in the foregoing method embodiment. The memory 4021 and the processor 4022 may serve the one or more boards. In other words, the memory and processor can be separately set on each board. Alternatively, a plurality of boards may share a same memory and a same processor. In addition, a necessary circuit may be further disposed on each board.

It should be understood that the network device 40 shown in FIG. 18 can implement functions of the network device in the method embodiments in FIG. 6 to FIG. 17. Operations and/or functions of units in the network device 40 are respectively used to implement corresponding procedures performed by the network device in the method embodiments of this application. To avoid repetition, detailed descriptions are appropriately omitted herein. The structure of the network device shown in FIG. 18 is merely a possible form, but should not constitute any limitation to this embodiment of this application. This application does not exclude a possibility that there may be a network device structure in another form in the future.

An embodiment of this application further provides a communications system, including the foregoing network device and one or more terminal devices.

This application further provides a computer-readable storage medium. The computer-readable storage medium stores instructions; and when the instructions are run on a computer, the computer is enabled to perform the steps performed by the network device in the methods shown in FIG. 6 to FIG. 14.

This application further provides a computer-readable storage medium. The computer-readable storage medium stores instructions; and when the instructions are run on a computer, the computer is enabled to perform the steps performed by the terminal device in the methods shown in FIG. 6 to FIG. 14.

This application further provides a computer program product including instructions; and when the computer program product is run on a computer, the computer is enabled to perform the steps performed by the network device in the methods shown in FIG. 6 to FIG. 14.

This application further provides a computer program product including instructions; and when the computer program product is run on a computer, the computer is enabled to perform the steps performed by the terminal device in the methods shown in FIG. 6 to FIG. 14.

This application further provides a chip, including a processor. The processor is configured to read and run a computer program stored in a memory, to perform a corresponding operation and/or procedure performed by the terminal device in the sidelink communications method provided in this application. Optionally, the chip further includes a memory. The memory and the processor are connected to the memory by using a circuit or a wire. The processor is configured to read and execute a computer program in the memory. Further, optionally, the chip includes a communications interface. The processor is connected to the communications interface. The communications interface is configured to receive data and/or information that needs to be processed. The processor obtains the data and/or information from the communications interface, and processes the data and/or information. The communications interface may be an input/output interface.

This application further provides a chip, including a processor. The processor is configured to invoke and run a computer program stored in a memory, to perform a corresponding operation and/or procedure performed by the network device in the sidelink communications method provided in this application. Optionally, the chip further includes a memory. The memory and the processor are connected to the memory by using a circuit or a wire. The processor is configured to read and execute a computer program in the memory. Further, optionally, the chip includes a communications interface. The processor is connected to the communications interface. The communications interface is configured to receive data and/or information that needs to be processed. The processor obtains the data and/or information from the communications interface, and processes the data and/or information. The communications interface may be an input/output interface.

In the foregoing embodiments, the processor may be a central processing unit (central processing unit, CPU), a microprocessor, an application-specific integrated circuit (application-specific integrated circuit, ASIC), one or more integrated circuits for controlling program execution in the technical solutions of this application, or the like. For example, the processor may be a digital signal processor device, a microprocessor device, an analog-to-digital converter, and a digital-to-analog converter. The processor may allocate control and signal processing functions of the terminal device or the network device between these devices based on respective functions of these devices. In addition, the processor may have a function of operating one or more software programs. The software programs may be stored in a memory. The function of the processor may be implemented by hardware, or may be implemented by hardware by executing corresponding software. The hardware or the software includes one or more modules corresponding to the foregoing function.

The memory may be a read-only memory (read-only memory, ROM), another type of static storage device that can store static information and an instruction, a random access memory (random access memory, RAM) or another type of dynamic storage device that can store information and an instruction, or may be an electrically erasable programmable read-only memory (electrically erasable programmable read-only memory, EEPROM), a compact disc read-only memory (compact disc read-only memory, CD-ROM) or another optical disc storage, an optical disc storage (including a compact optical disc, a laser disc, an optical disc, a digital versatile optical disc, a Blu-ray disc, and the like), a magnetic disk storage medium or another magnetic storage device, or any other medium that can be used to carry or store expected program code in an instruction or data structure form and that can be accessed by a computer.

Optionally, the memory and the processor may be physically independent units, or the memory may be integrated into the processor.

In the embodiments of this application, the term “at least one” means one or more, and the term “a plurality of” means two or more. The term “and/or” describes an association relationship for describing associated objects and represents that three relationships may exist. For example, A and/or B may represent the following three cases: Only A exists, both A and B exist, and only B exists. A and B may be singular or plural. The character “I” usually indicates an “or” relationship between the associated objects. The term “at least one item of the following” or a similar expression thereof means any combination of the items, including any combination of singular items or plural items. For example, at least one of a, b, and c may indicate a, b, c, a and b, a and c, b and c, or a, b, and c, where a, b, and c may be singular or plural.

A person of ordinary skill in the art may be aware that units, algorithms, and steps described in the embodiments disclosed in this application can be implemented by electronic hardware or a combination of computer software and electronic hardware. Whether the functions are performed by hardware or software depends on particular applications and design constraint conditions of the technical solutions. A person skilled in the art may use different methods to implement the described functions of each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, the disclosed system, apparatus, and method may be implemented in other manners. For example, the described apparatus embodiments are merely examples. For example, division into units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may not be physically separate, and parts displayed as units may not be physical units, and may be located in one position, or may be distributed on a plurality of network units. Some or all of the units may be selected based on an actual requirement to achieve the objectives of the technical solutions of this application.

In addition, function units in the embodiments of this application may be integrated into one processing unit, or each of the units may exist alone physically, or two or more units are integrated into one unit.

When the functions are implemented in a form of a software function unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, or a network device) to perform all or some of the steps of the method described in the embodiments of this application. The storage medium includes any medium that can store program code such as a USB flash drive, a removable hard disk, a read-only memory (read-only memory, ROM), a random access memory (random access memory, RAM), a magnetic disk, or an optical disc.

The foregoing descriptions are merely specific implementations of this application. Any variation or replacement readily figured out by a person skilled in the art within the technical scope disclosed in this application shall fall within the protection scope of this application. The protection scope of this application shall be subject to the protection scope of the claims.

What is claimed is:

1. A sidelink communications method, comprising:
receiving, by a terminal device, downlink control information from a network device, wherein the downlink control information carries first indication information, the first indication information is used to indicate slot formats corresponding to N1 terminal device groups, and one terminal device group comprises a plurality of terminal devices that perform sidelink groupcast communication, wherein N1 is a positive integer; and
parsing, by the terminal device, the downlink control information.

2. The method according to claim 1, wherein N1 is equal to 1; and
that the first indication information is used to indicate slot formats corresponding to N1 terminal device groups comprises:
the first indication information is used to indicate slot formats corresponding to N terminal devices in a first terminal device group, the first indication information comprises N information segments, and one of the N information segments is used to indicate a slot format corresponding to one terminal device in the first terminal device group.

3. The method according to claim 1, wherein N1 is greater than 1; and
the first indication information is used to indicate the slot formats corresponding to the N1 terminal device groups, the first indication information comprises N1 information segments, and one of the N1 information segments is used to indicate a slot format corresponding to one of the N1 terminal device groups.

4. The method according to claim 2, wherein a correspondence between the N information segments and the N terminal devices is preconfigured, or the method further comprises:
receiving, by the terminal device, a second message from the network device, wherein the second message comprises a correspondence between the N information segments and the N terminal devices.

5. The method according to claim 2, wherein the downlink control information further comprises second indication information, and the second indication information is used to identify the N terminal devices.

6. The method according to claim 5, wherein the second indication information comprises an identifier of a start terminal device in the N terminal devices; or
the second indication information comprises an identifier of each of the N terminal devices.

7. The method according to claim 3, wherein a correspondence between the N1 information segments and the N1 terminal device groups is preconfigured, or the method further comprises:
receiving, by the terminal device, a third message from the network device, wherein the third message comprises a correspondence between the N1 information segments and the N1 terminal device groups.

8. An apparatus, comprising:
a memory storage comprising instructions; and
one or more processors in communication with the memory storage, wherein the execution of the instructions by the one or more processors causes the apparatus to:
determine downlink control information, wherein the downlink control information carries first indication information, the first indication information is used to indicate slot formats corresponding to N1 terminal device groups, and one terminal device group comprises a plurality of terminal devices that perform sidelink groupcast communication, wherein N1 is a positive integer; and
send the downlink control information.

9. The apparatus according to claim 8, wherein N1 is equal to 1; and
that the first indication information is used to indicate slot formats corresponding to N1 terminal device groups comprises:
the first indication information is used to indicate slot formats corresponding to N terminal devices in a first terminal device group, the first indication information comprises N information segments, and one of the N information segments is used to indicate a slot format corresponding to one terminal device in the first terminal device group, wherein N is a positive integer.

10. The apparatus according to claim 8, wherein N1 is greater than 1; and
the first indication information is used to indicate the slot formats corresponding to the N1 terminal device groups, the first indication information comprises N1 information segments, and one of the N1 information segments is used to indicate a slot format corresponding to one of the N1 terminal device groups.

11. The apparatus according to claim 9, wherein a correspondence between the N information segments and the N terminal devices is preconfigured, or the sending unit is further configured to send a second message to the N terminal devices, wherein the second message comprises a correspondence between the N information segments and the N terminal devices.

12. The apparatus according to claim 9, wherein the downlink control information further comprises second indication information, and the second indication information is used to identify the N terminal devices.

13. The apparatus according to claim 12, wherein the second indication information comprises an identifier of a start terminal device in the N terminal devices; or
the second indication information comprises an identifier of each of the N terminal devices.

14. The apparatus according to claim 10, wherein a correspondence between the N1 information segments and the N1 terminal device groups is preconfigured, or the sending unit is further configured to send a third message to terminal devices in the N1 terminal device groups, wherein the third message comprises a correspondence between the N1 information segments and the N1 terminal device groups.

15. An apparatus, comprising:
a memory storage comprising instructions; and
one or more processors in communication with the memory storage, wherein the execution of the instructions by the one or more processors causes the apparatus to:
receive downlink control information from a network device, wherein the downlink control information carries first indication information, the first indication information is used to indicate slot formats corresponding to N1 terminal device groups, and one terminal device group comprises a plurality of terminal devices that perform sidelink groupcast communication, wherein N1 is a positive integer; and
parse the downlink control information.

16. The apparatus according to claim 15, wherein N1 is equal to 1; and
that the first indication information is used to indicate slot formats corresponding to N1 terminal device groups comprises:
the first indication information is used to indicate slot formats corresponding to N terminal devices in a first terminal device group, the first indication information comprises N information segments, and one of the N information segments is used to indicate a slot format corresponding to one terminal device in the first terminal device group, wherein N is a positive integer.

17. The apparatus according to claim 15, wherein N1 is greater than 1; and
the first indication information is used to indicate the slot formats corresponding to the N1 terminal device groups, the first indication information comprises N1 information segments, and one of the N1 information segments is used to indicate a slot format corresponding to one of the N1 terminal device groups.

18. The apparatus according to claim 16, wherein a correspondence between the N information segments and the N terminal devices is preconfigured, or the receiving unit is further configured to receive a second message from the network device, wherein the second message comprises a correspondence between the N information segments and the N terminal devices.

19. The apparatus according to claim 16, wherein the downlink control information further comprises second indication information, and the second indication information is used to identify the N terminal devices.

20. The apparatus according to claim 19, wherein the second indication information comprises an identifier of a start terminal device in the N terminal devices; or
the second indication information comprises an identifier of each of the N terminal devices.
